(19) United States
(12) Patent Application Publication
(10) Pub. No.: US 2021/0362763 A1
(43) Pub. Date: Nov. 25, 2021

(54) Vehicle, Trailer, and Cart Control Systems

(71) Applicant: Urban Electric Co., Pasadena, CA (US)

(72) Inventors: Sven Etzelsberger, Pasadena, CA (US); Peter Lee, Pasadena, CA (US)

(73) Assignee: Urban Electric Co., Pasadena, CA (US)

(21) Appl. No.: 17/326,206

(22) Filed: May 20, 2021

Related U.S. Application Data
(60) Provisional application No. 63/027,661, filed on May 20, 2020.
(60) Provisional application No. 63/049,547, filed on Jul. 8, 2020.
(60) Provisional application No. 63/091,842, filed on Oct. 14, 2020.
(60) Provisional application No. 63/140,027, filed on Jan. 21, 2021.

(51) Int. Cl. B62B 3/02; B62B 5/04; B62B 3/00; B62B 5/00; B62K 15/00; B60B 19/00

(52) U.S. Cl. CPC B62B 3/025; B62B 5/04; B62B 3/002; B62K 2202/00; B62K 15/006; B60B 19/003; B62B 5/0026

(57) ABSTRACT

Multi-level delivery systems and various apparatus associated therewith are presented. Multi-level delivery systems include a number of integrated, modular and interchangeable compactible elements that may work either alone or in conjunction with other such elements to allow for the deployment of a delivery system having a smaller overall spatial footprint when compared to comparable conventional delivery systems. Apparatus combining to form a delivery system may include one or more of: a compactible container cart, a compactible cart hauler or trailer, a propulsion means, and/or a maneuverability means. These elements or apparatus may be deployed in any combination, either together as an integrated system or with compatible conventional apparatus. In combination, delivery systems maximize space efficiency, and allow for adaption to any environment and scale.

### CROSS-REFERENCED APPLICATIONS

This application claims priority to U.S. Provisional applications 63/027,661 filed on May 20, 2020, 63/049,547 filed on Jul. 8, 2020, 63/091,842 filed on Oct. 14, 2020, and 63/140,027 filed on Jan. 21, 2021. The disclosures of which are included herein by reference in their entirety.

### FIELD OF THE INVENTION

The present invention relates to a multi-level delivery system, and more particularly to a multi-level delivery system incorporating compactible carts, trailers and propulsion devices.

### BACKGROUND OF THE INVENTION

Online shopping is a form of electronic commerce which allows consumers to directly buy goods or services from a seller over the Internet using a web browser. Consumers find a product of interest by visiting the website of the retailer directly or by searching among alternative vendors using a shopping search engine, which displays the same product's availability and pricing at different e-retailers. As of 2020, customers can shop online using a range of different computers and devices, including desktop computers, laptops, tablet computers, smartphones, and smart speakers.

The popularity of online shopping continues to erode sales of conventional retailers. For example, Best Buy, the largest retailer of electronics in the U.S. in August 2014 reported its tenth consecutive quarterly dip in sales, citing an increasing shift by consumers to online shopping. Meanwhile, as of May 2018, a survey found two-thirds of Americans had bought something from Amazon (92% of those who had bought anything online), with 40% of online shoppers buying something from Amazon at least once a month. Moreover, the expansion of online shopping is a worldwide phenomenon. There were 242 million people shopping online in China in 2012.

One major issue to the continued expansion of online retail is a solution to the logistics of the delivery of physical products, particularly in crowded metropolitan areas which are not well-suited to last mile shipping solutions involving large trucks and warehouse infrastructure. Additionally, while some delivery methods have turned to things like bicycles and associated accessories, such systems and methods still suffer from a number of issues when navigating crowded metropolitan areas.

For example, bicycle trailers or wagons have been used in a number of industries, including recreation and delivery. Typically, a trailer or wagon can be configured to transport any number of items ranging from packages to people to be transported from one place to another. Trailers often have a platform attached to at least one set of wheels and then an attachment mechanism to connect the trailer to the towing vehicle. Similar to trailers designed for cars, bicycle trailers often have a single attachment point near the rear of the vehicle. Some bicycle trailers can connect to the rear axle and others have connection devices that connect to the frame of the bicycle.

Since many connectors for bicycles for trailers and/or wagons are limited, the movement of such trailer can be challenging when reversing the trailer into a desired position. This is especially true for smaller tighter positions that are often seen in crowded environments. For example, a trailer tends to move in an opposite direction from that of the steering mechanism. This can make rearward movement of the trailer or wagon difficult in relation to the pivot ability and movement capabilities of the bicycle. This can be especially true for bicycles due to only having two wheels for movement. Although manufacturers have come up with various new trailer designs and attachment mechanisms, typical devices tend to still be subject to the limitations of the wheeled vehicle that is towing the trailer.

### SUMMARY OF THE INVENTION

Embodiments are directed multi-level delivery systems and multi-level delivery systems incorporating compactible carts, trailers and propulsion devices.

Many embodiments are directed to compactible carts including:
a support structure comprising a pair of longitudinal sidewall elements disposed parallel to each other and a pair of latitudinal end wall elements disposed parallel to each other, wherein the sidewall and end wall elements are pivotably interconnected at each end to each other such that said sidewall and end wall elements may be rotated between a first wall position where the sidewalls and end walls are disposed orthogonal to each other forming an internal volume and a second wall position where the sidewalls and end walls are disposed parallel to each other;
at least a top platform element pivotably interconnected to one of either the sidewall or end wall elements at an upper end thereof, and a bottom platform element pivotably interconnected to one of either the sidewall or the end wall elements at a lower end thereof, such that said internal platform elements may be rotated between a first platform position where said internal platform elements are disposed parallel to the side and end walls and a second platform position where said internal platform elements are disposed perpendicular to the side and end walls; and
a plurality of wheels disposed below the bottom platform, wherein at least one wheel is disposed at each of the corners of the cart;
wherein the elements of the cart are configured such that when at least one of the top or bottom platform elements are disposed in the second platform position the sidewall and end wall elements are prevented from pivoting.

Still many embodiments include at least one internal platform element pivotably interconnected to one of either the sidewall or end wall elements between the upper and lower ends thereof.

In yet many embodiments each of at least the internal and bottom platform elements are formed of two platform elements each pivotably interconnected to opposing sidewall or end wall elements.

In still yet many embodiments each of the sidewalls and end walls are open such that the internal volume is open.

In still yet many embodiments each of the sidewalls and end walls are solid to enclose the internal volume.

In still yet many embodiments the at least one of longitudinal sidewall element is pivotably connected to an upper portion of the support structure such that the sidewall may be rotated relative to the support structure providing access to the internal volume.

In still yet many embodiments the at least one pivotably connect longitudinal sidewall element is formed of two pivotably interconnected longitudinal sidewall portions.

Still yet many embodiments include at least one latch configured to secure the at least one pivotably connected longitudinal sidewall element from rotation relative to the support structure.

In still yet many embodiments the top platform and pivotably connected longitudinal sidewall are hinged together such that only one may be rotated relative to the support structure at a time.

Still yet many embodiments include at least one latch configured to secure the top platform from rotation relative to the support structure.

Some embodiments are directed to compactible haulers including:
a frame supporting a platform, wherein said frame and platform are formed of at least front and rear portions pivotably interconnected along a longitudinal axis thereof such that said at least two portions may be rotated between a first position where the portions are disposed in-line with each other and a second position where the portions are disposed in adjacent parallel planes; and
at least two sets of wheels, wherein at least one set of wheels is disposed on a front portion and wherein at least one set of wheels is disposed on a rear portion, and wherein when the portions are disposed in the second position the sets of wheels overlap;
wherein the rear wheels are pivotable relative to the frame and platform such that in a first position the rear and portions are disposed at the same height, and wherein in a second position the rear portion is dispose at a height lower than the front portion.

In yet some embodiments a single wheel is disposed on the front portion and a set of two wheels are disposed on the rear portion.

In still some embodiments the platform further comprises a center open section configured such that the single wheel on the front portion passes at least partially therethrough when disposed in the second position.

Still yet some embodiments include a surge braking mechanism disposed on the front portion.

In still yet many embodiments the surge braking mechanism includes:
at least a first brake support member interconnected with the hauler frame;
at least a second brake support member pivotably interconnected with the first brake support member and configured to be interconnected with a propulsion device at an end distal to the second brake support member;
a pneumatic brake element having a pneumatic cylinder fixedly interconnected to the second brake support member, and a rod having a resilient member disposed thereon, the rod slidingly engaged within the pneumatic cylinder at a first end and fixedly interconnected to the first brake support member;
wherein when the first brake support member is pivoted in the direction of the second brake support member the rod is pushed into the pneumatic cylinder applying the braking mechanism.

Various embodiments are directed to delivery systems including:
a compactible hauler including:
   a frame supporting a platform, wherein said frame and platform are formed of at least front and rear portions pivotably interconnected along a longitudinal axis thereof such that said at least two portions may be rotated between a first position where the portions are disposed in-line with each other and a second position where the portions are disposed in adjacent parallel planes, and
   at least two sets of wheels, wherein at least one set of wheels is disposed on a front portion and wherein at least one set of wheels is disposed on a rear portion, and wherein when the portions are disposed in the second position the sets of wheels overlap,
   wherein the rear wheels are pivotable relative to the frame and platform such that in a first position the rear and portions are disposed at the same height, and wherein in a second position the rear portion is dispose at a height lower than the front portion; and
   wherein the platform is configured to support a compactible cart including:
      a support structure comprising a pair of longitudinal sidewall elements disposed parallel to each other and a pair of latitudinal end wall elements disposed parallel to each other, wherein the sidewall and end wall elements are pivotably interconnected at each end to each other such that said sidewall and end wall elements may be rotated between a first wall position where the sidewalls and end walls are disposed orthogonal to each other forming an internal volume and a second wall position where the sidewalls and end walls are disposed parallel to each other,
      at least a top platform element pivotably interconnected to one of either the sidewall or end wall elements at an upper end thereof, and a bottom platform element pivotably interconnected to one of either the sidewall or the end wall elements at a lower end thereof, such that said internal platform elements may be rotated between a first platform position where said internal platform elements are disposed parallel to the side and end walls and a second platform position where said internal platform elements are disposed perpendicular to the side and end walls, and
      a plurality of wheels disposed below the bottom platform, wherein at least one wheel is disposed at each of the corners of the cart,
      wherein the elements of the cart are configured such that when at least one of the top or bottom platform elements are disposed in the second platform position the sidewall and end wall elements are prevented from pivoting.

Still various embodiments include a propulsion device interconnectable with the compactible hauler.

In yet various embodiments the propulsion device is a compactible electric scooter.

Embodiments are also directed to methods of delivering packages including:
delivering goods to a distribution center;
organizing said goods onto one or more compactible carts including:
   a support structure comprising a pair of longitudinal sidewall elements disposed parallel to each other and a pair of latitudinal end wall elements disposed parallel to each other, wherein the sidewall and end wall elements are pivotably interconnected at each end to each other such that said sidewall and end wall elements may be rotated between a first wall position where the sidewalls and end walls are disposed orthogonal to each other forming an internal volume and a second wall position where the sidewalls and end walls are disposed parallel to each other,
   at least a top platform element pivotably interconnected to one of either the sidewall or end wall elements at an upper end thereof, and a bottom platform element pivotably interconnected to one of either the sidewall or the end wall elements at a lower end thereof, such that said internal platform elements may be rotated between a first platform position where said internal platform elements are disposed parallel to the side and end walls and a second platform position where said internal platform elements are disposed perpendicular to the side and end walls, and
   a plurality of wheels disposed below the bottom platform, wherein at least one wheel is disposed at each of the corners of the cart,
   wherein the elements of the cart are configured such that when at least one of the top or bottom platform elements are disposed in the second platform position the sidewall and end wall elements are prevented from pivoting;
loading said compactible carts onto one or more compactible haulers including:
   a frame supporting a platform, wherein said frame and platform are formed of at least front and rear portions pivotably interconnected along a longitudinal axis thereof such that said at least two portions may be rotated between a first position where the portions are disposed in-line with each other and a second position where the portions are disposed in adjacent parallel planes, and
   at least two sets of wheels, wherein at least one set of wheels is disposed on a front portion and wherein at least one set of wheels is disposed on a rear portion, and wherein when the portions are disposed in the second position the sets of wheels overlap,
   wherein the rear wheels are pivotable relative to the frame and platform such that in a first position the rear and portions are disposed at the same height, and wherein in a second position the rear portion is dispose at a height lower than the front portion; and
interconnecting each compactible hauler with a propulsion system to deliver said goods.

In other embodiments, the hauler has a deployment mechanism disposed on a portion of the frame wherein the deployment mechanism is interconnected with the rear wheels such that a movement of the deployment mechanism can pivot the rear wheels between the first and second positions.

In yet other embodiments, the hauler has a resilient element connected to the pivotable rear wheels wherein the resilient element is configured to apply a force against the rear wheels in either the first or second positions such that the hauler will remain fixed in either position.

In still other embodiments, the resilient element is connected to the frame through a plurality of pivotable elements and wherein the pivotable elements are disposed to the rear of the pivotable rear wheel.

In still yet other embodiments, the resilient element is connected to the frame through a plurality of pivotable elements and wherein the pivotable elements are disposed to forward of the pivotable rear wheel.

In other embodiments, the platform is disposed at a height of below five feet to the ground.

In still other embodiments, the hauler has a set of elongated illuminated masts disposed at each of the approximate corners of the frame and configured to pivot between a first configuration where the elongated illuminated masts-extends above and normal to the plane of the frame, and a second configuration where the elongated illuminated masts extend along the plane of the frame.

Other embodiments are directed to systems that utilize a compactible electric scooter as a propulsion device.

Still other embodiments are directed to a vehicle maneuverability device that has a frame structure having at least one connection point and configured to cooperatively and rotatably engage with a vehicle frame work at a corresponding connection location on the vehicle framework, and wherein the at least one connection point is disposed at a first end of the frame structure. Additionally, the device has at least one axle disposed on a lower portion of the frame structure wherein the at least one axle is configured to cooperatively engage with at least one wheel such that the length of the frame structure between the at least one connection point and an outer surface of the wheel is longer than a distance between the corresponding connection location and an outer surface of a vehicle tire. The frame structure has a disengaged position and an engaged position and can be rotated or moved between both the disengaged and engaged positions. In the disengaged position the at least one wheel is located rearward of the vehicle tire. In the engaged position the at least one wheel is located lower than the vehicle tire such that the at least one wheel is in contact with the ground and the vehicle tire is not in contact with the ground.

In other embodiments, the at least one wheel is an omnidirectional wheel.

In still other embodiments, the omnidirectional wheel is a Mecanum wheel.

In yet other embodiments, the frame structure is a “U” shape and wherein the at least one axle is disposed near the bottom curved portion of the “U” shape.

In still yet other embodiments, the device has a second axle disposed on the frame structure on an opposing side of the at least one axle such that the position on each side of the frame structure of the at least one and second axles is equal.

In other embodiments, the device has at least a second wheel disposed on the second axle.

In still other embodiments, each of the first and second wheels are omnidirectional wheels.

In yet other embodiments, the device has an engagement mechanism having a first end that is connected to a portion of the frame structure and a second end connected to the vehicle frame work, wherein the engagement mechanism provides mechanical assistance to move the device between the engaged and disengaged positions.

In yet other embodiments, the engagement mechanism holds the device in the disengaged position without additional external force.

In still yet other embodiments, the engagement mechanism is a spring and/or a hydraulic device.

Other embodiments are directed to a delivery system with at least one wheeled hauler comprising a frame supporting a platform. The platform is configured to support a rollable cart defining an internal volume thereon. Additionally, the system has at least one propulsion unit configured to interconnect with the wheeled hauler and provide propulsion. The system is also configured with a location determining unit disposed in one of either the hauler or propulsion unit and configured to record at least one set of data on at least the location and distance travelled. The system also has a set of electrical connectors configured to provide electrical and signal interconnection between at least the hauler and propulsion unit when interconnected. Interconnecting any one hauler and any one propulsion unit provides identifying information of each to said location determining unit such that the recorded data is applied to both the interconnected hauler and propulsion units.

In other embodiments, the electrical connectors further provide signal and electrical interconnection to the cart such that the cart is identified to the location unit and the recorded data is applied to the cart.

In yet other embodiments, the location unit and a power supply to power said location unit are disposed on the propulsion unit.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

### BRIEF DESCRIPTION OF THE DRAWINGS

These and other features and advantages of the present invention will be better understood by reference to the following detailed description when considered in conjunction with the accompanying data and figures, wherein:

FIG. 1 provides a flowchart of a multilevel delivery system in accordance with embodiments.

FIGS. 2A to 2C provide schematic illustrations of a compactible container in accordance with embodiments.

FIG. 3 provides a schematic of a truck loading scheme in accordance with the prior art.

FIG. 4 provides a schematic of a truck loading scheme in accordance with embodiments.

FIG. 5 provides a schematic of a container loading scheme in accordance with the prior art.

FIG. 6 provides a schematic of a container loading scheme in accordance with embodiments.

FIG. 7A provides a schematic perspective illustration of a compactible container in accordance with embodiments.

FIGS. 7B and 7C provide schematic side view illustrations of a compactible container in an unfolded (8A) and compacted (8B) configuration in accordance with embodiments.

FIG. 7D provides a schematic top perspective view illustration of a compactible container in accordance with embodiments.

FIG. 8A provides a schematic perspective view illustration of a fully enclosed compactible container in accordance with embodiments.

FIGS. 8B and 8C provide schematic perspective illustrations of a compactible container with foldable sidewall in accordance with embodiments.

FIG. 9 provides a schematic perspective illustration of a compactible container with open top platform in accordance with embodiments.

FIGS. 10A and 10B provide close-up schematic illustrations of a hinge mechanism of a compactible container in accordance with embodiments.

FIGS. 11A and 11B provide schematic perspective illustrations of a compactible container with foldable internal platforms in accordance with embodiments.

FIG. 12 provides a schematic of a method of folding a compactible container in accordance with embodiments.

FIGS. 13A to 13C provide schematic top view illustrations of the folding of a compactible container in accordance with embodiments.

FIG. 14 provides a schematic of a number of stacked compactible containers in accordance with embodiments.

FIG. 15 provides a schematic of a hauler staging scheme in accordance with the prior art.

FIG. 16 provides a schematic of a hauler staging scheme in accordance with embodiments.

FIG. 17A provides a schematic top perspective illustration of a compactible hauler in an unfolded configuration in accordance with embodiments.

FIG. 17B provides a schematic top perspective illustration of a compactible hauler in a folded configuration in accordance with embodiments.

FIG. 17C provides a schematic bottom perspective illustration of a compactible hauler in accordance with embodiments.

FIG. 18A provides a schematic side-view illustration of a compactible hauler in a raised configuration in accordance with embodiments.

FIG. 18B provides a schematic side-view illustration of a compactible hauler in a lowered configuration in accordance with embodiments.

FIG. 19A provides a schematic side-view illustration of a loaded compactible hauler in accordance with embodiments.

FIG. 19B provides a schematic top-view illustration of a loaded compactible hauler in accordance with embodiments.

FIG. 20 provides a schematic perspective view illustration of a braking mechanism in accordance with embodiments.

FIGS. 21A and 21B provide schematics of a braking mechanism during operation in accordance with embodiments.

FIG. 22A provides a schematic side-view illustration of a compactible hauler in a raised configuration during loading in accordance with embodiments.

FIG. 22B provides a schematic side-view illustration of a compactible hauler in a lowered configuration during loading in accordance with embodiments.

FIGS. 23A to 23C provide schematic illustrations of locking mechanisms for compactible haulers and containers in accordance with embodiments.

FIGS. 24A and 24B provide schematic top-view illustrations of loaded compactible haulers connected with propulsion devices in accordance with embodiments.

FIG. 25 provides a schematic illustration of a delivery system incorporating compactible containers, haulers and propulsion systems in accordance with embodiments.

FIG. 26 provides a schematic illustration of a modular delivery system incorporating a modular location system in accordance with embodiments.

FIGS. 27A and 27B provide images of a hauler with collapsible light masts in accordance with embodiments.

FIGS. 28A and 28B provide images of a collapsible light mast mechanism in accordance with embodiments.

FIG. 29 provides an image of a connector for a light mast in accordance with embodiments.

FIG. 30 provides a schematic of a multi-axial trailer hitch system in accordance with embodiments of the invention.

FIG. 31 provides a side view of a vehicle directional control device attached to a vehicle in accordance with embodiments of the invention.

FIG. 32 provides an isometric review of a vehicle directional control device in accordance with embodiments of the invention.

FIG. 33 provides a vehicle directional control device in an engaged position in accordance with embodiments of the invention.

FIG. 34 provides a view of a vehicle directional control device in a disengaged position in accordance with embodiments of the invention.

FIG. 35 provides a view of several vehicle directional control devices in accordance with embodiments of the invention.

### DETAILED DISCLOSURE

The embodiments of the invention described herein are not intended to be exhaustive or to limit the invention to precise forms disclosed. Rather, the embodiments selected for description have been chosen to enable one skilled in the art to practice the invention.

Turning now to the drawings, a multi-level delivery system and various apparatus associated therewith are presented. In many embodiments a multi-level delivery system includes a number of integrated, modular and interchangeable compactible elements that may work either alone or in conjunction with other such elements to allow for the deployment of a delivery system having a smaller overall spatial footprint when compared to comparable conventional delivery systems. Embodiments of apparatus combining to form a delivery system may include one or more of: a compactible container cart, a compactible cart hauler or trailer and a propulsion means. These elements or apparatus may be deployed in any combination, either together as an integrated system or with compatible conventional apparatus. In combination, a delivery system in accordance with embodiments maximizes space efficiency, and allows for adaption to any environment and scale.

With the rise of online marketplaces delivery, and more particularly delivery in dense population centers presents significant challenges. Specifically, while warehouses outside of metropolitan areas are efficient at holding goods for shipment into the city, the last mile shipping, that is getting the goods from the warehouse to customers in the city center, creates enormous complications. Typically, shippers rely on the ability to transport everything from the warehouse directly to customers in trucks. While direct shipping is possible, albeit inefficient and environmentally destructive, in less dense areas, in highly dense cities street parking for large trucks is either insufficient or unavailable. In these highly dense urban cores it is necessary for shippers to develop an infrastructure of distribution centers within the city from which deliveries may be transferred from large trucks to smaller vehicles including in many cases bicycle and cart delivery vehicles.

While such distribution centers and more local delivery means may address the problem of street parking, current solutions are unwieldy and inefficient. Specifically, the requirement for distribution locations in city centers increases costs for shippers. Moreover, existing urban delivery vehicles are large and inflexible, requiring excessive space both during use and when not in use and being stored. Also, many of these delivery vehicles simply were not designed for the use case and so are not sufficiently durable or compatible with the task. Finally, deliveries tend to surge during specific times of the day and year. Current delivery vehicles do not allow for efficient storage during down times meaning that adding delivery capacity is difficult or impossible. Embodiments of the instant disclosure are directed to a multi-level delivery system that is space efficient, flexible and compatible with many different delivery methods.

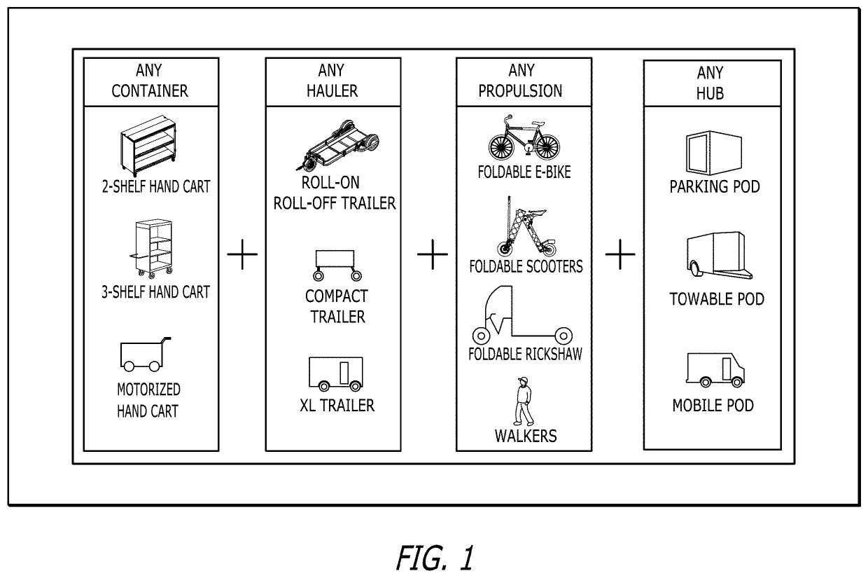

Turning to the figures, many embodiments may include several levels of different apparatus that can be used in conjunction to create an integrate delivery system. As shown in FIG. 1, various such embodiments may include containers, such as motorized or unmotorized carts, hauler or trailers for moving the containers from distribution centers to the customer, and a propulsion device, such as a bike, e-bike, rickshaw, electric scooter, etc. These delivery apparatuses may also be combined with a static or movable pod for storing the delivery components when not in use. Although specific embodiments of containers, haulers and propulsion apparatuses are set forth in the following sections, it will be understood that more broadly these apparatuses when taken in combination according to embodiments allow for compatible elements to be combined in different configurations depending on the specific need.

### Embodiments Implementing Compactible Containers

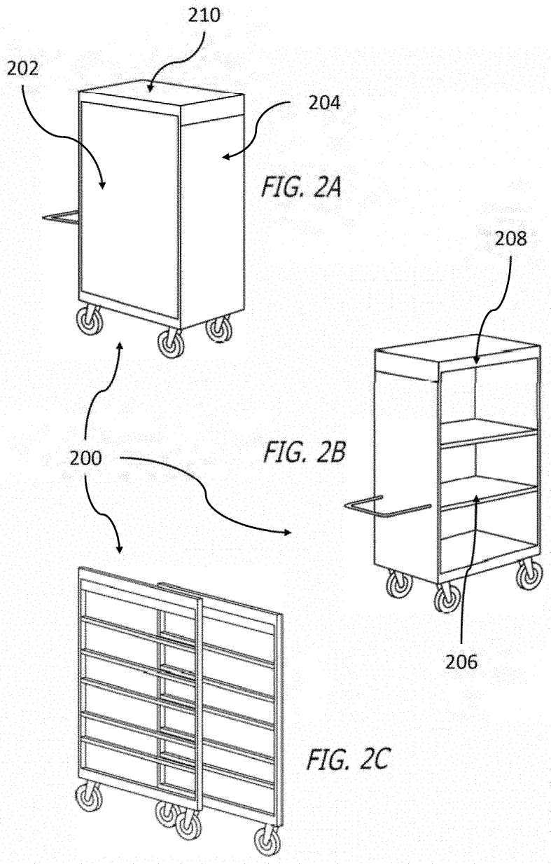

Various embodiments incorporate compactible wheeled cart containers having at least two operational configurations, unfolded (2A and 2B) and folded (2C). In many such embodiments, the compactible cart 200 has a first unfolded configuration where longitudinal and latitudinal side walls (202 & 204) are orthogonal to each other, and where the interior platforms 206 are set in horizontal configurations orthogonal to the planes of the side walls, and at least a second compacted configuration where both the longitudinal and latitudinal side walls (202 & 204) are disposed parallel to each other and where the interior platforms 206 are folded into a configuration parallel to the planes of the sidewalls, as shown in FIGS. 2A to 2C. In various other embodiments, each level of interior platform is formed of two separate hinged platform elements. In some embodiments each of two edges of the latitudinal walls are pivotably connected to different edges of the longitudinal walls. In various embodiments, at least one of the sidewalls (202 and/or 204) is comprised of two sidewall portions, which are pivotably connected to each other. In other words, two adjacent sidewalls (202 and/or 204) may be pivotably connected to each other such that can fold parallel to each other. In many such embodiments, one of two sidewall portions is itself pivotably connected to a sidewall support beam 208 configured to span between the two adjacent sidewalls. Some embodiments further comprise a top portion 210 itself pivotable connected along the edge of at least one of the sidewalls.

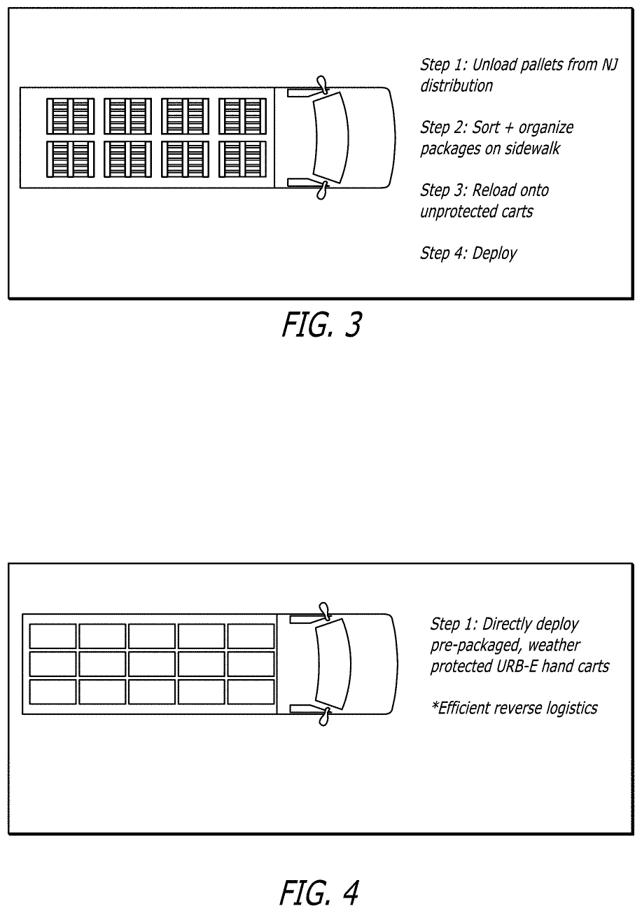

The use of such cart containers addresses a number of specific problems with the current delivery infrastructure. In conventional delivery systems, as shown in FIG. 3, product is delivered from the warehouse to the distribution center on pallets that must be unloaded (often where space is unavailable on a public throughway such as a sidewalk) and then sorted, organized and reloaded onto delivery carts that are then deployed for deliveries. Using an integrated delivery system according to embodiments, deliveries can be organized, sorted and loaded into cart containers at the warehouse and shipped directly to the distribution center in a preloaded configuration, as shown in FIG. 4.

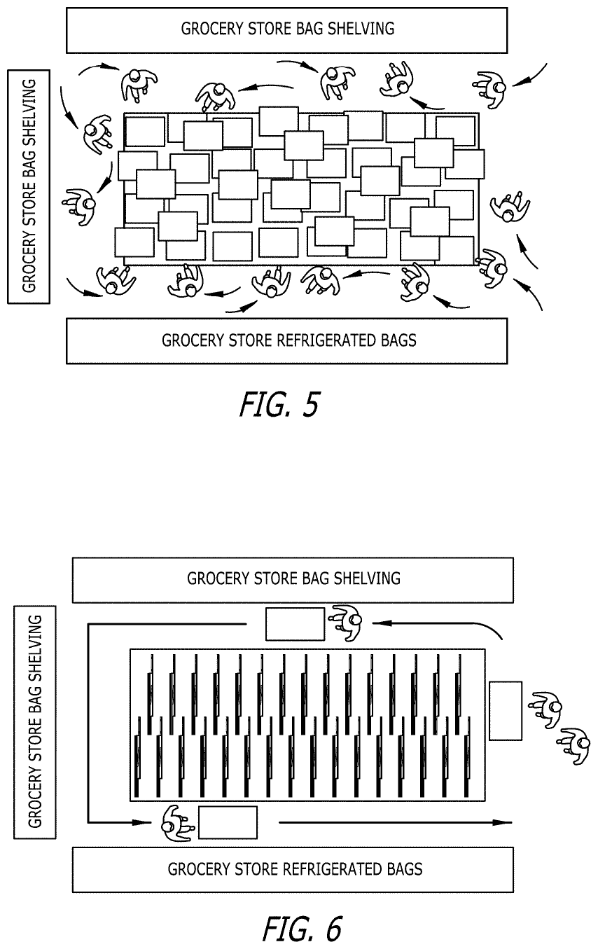

Moreover, even where product is delivered to distribution centers using a conventional pallet system, embodiments allow for the more efficient organization and sorting of such product. Specifically, as shown in FIG. 5, the current method of sorting product at a distribution center is disorganize and cumbersome. Typically, product is placed in shelves about a center open area where the delivery container is stored. Product is then selected from the shelves and inserted into appropriate containers for delivery. Such systems are time consuming and lack an organizing flow, requiring sorters to take many trips back and for between various shelves and the containers. By contrast, embodiments propose a system in which compactible wheeled carts are disposed in a central area, unfolded, and then moved around the shelves of the distribution center in a systematic racetrack manner, as shown in FIG. 6. Such a single direction flow allows for efficient sorting and organization of deliveries within the cart containers according to embodiments.

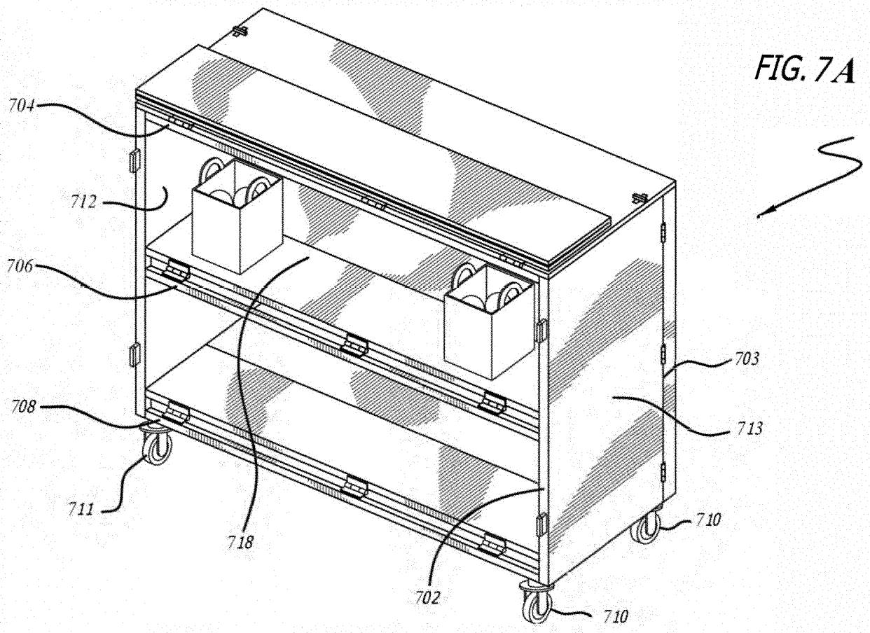

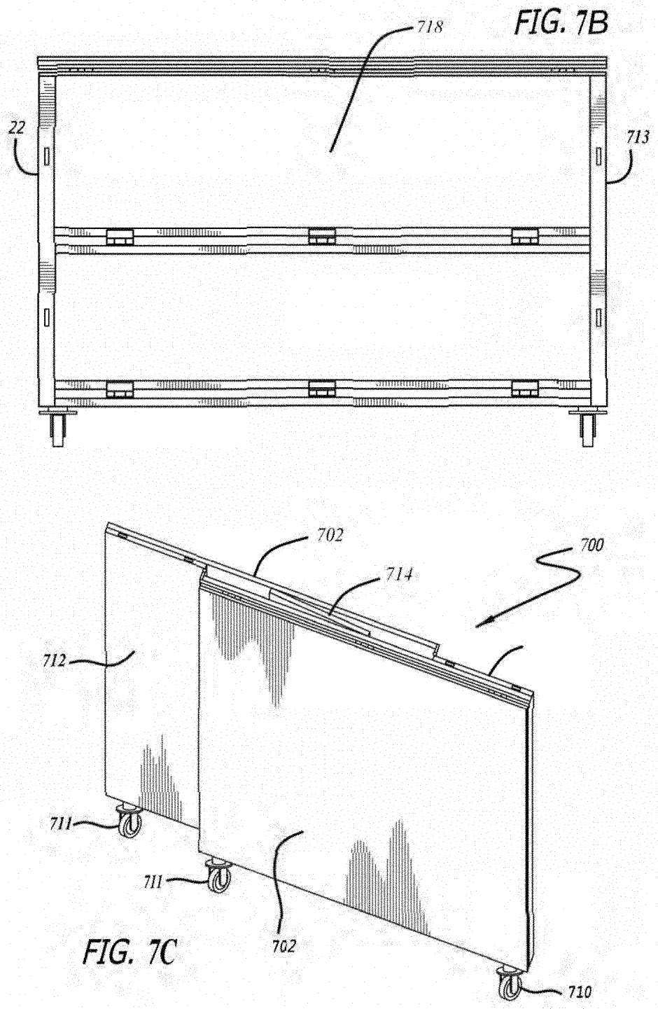

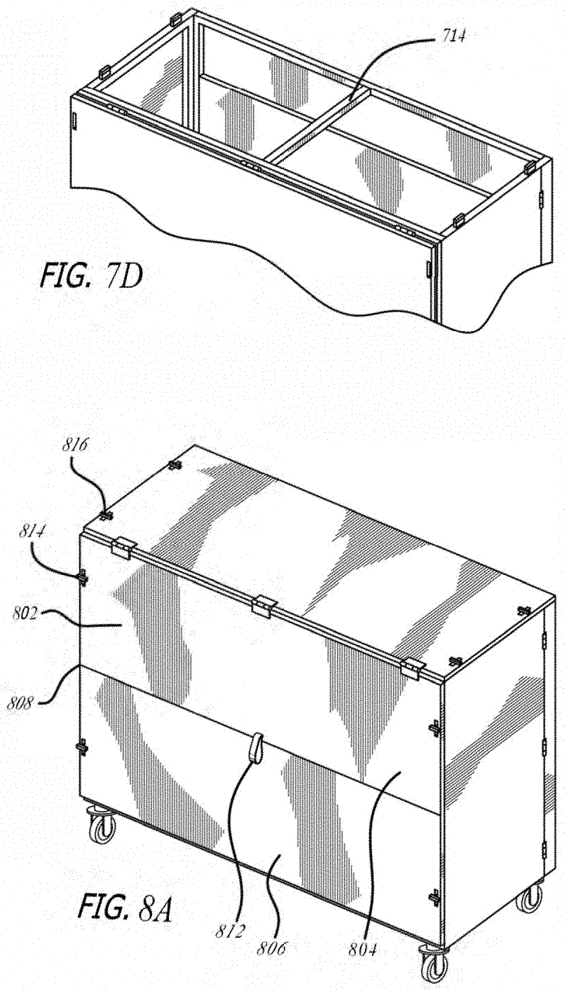

Such a system is only possible provided cart container embodiments, as described and shown in FIGS. 6A to 6C, capable of being compacted such that a central racetrack system may be disposed within the footprint of a distribution center. The construction of such compactible container carts according to embodiments is discussed in greater detail with respect to FIGS. 7 to 17.

As shown in FIG. 7, in many embodiments the compactible carts 700 are comprised of a pair of side frame structures (702 & 703) having upper 704, lower 706 and middle 708 elongated supports, and at least two sets of wheels (710 & 711) disposed along the lower beams of each of the frame structures. In many embodiments, the frame structures are pivotably interconnected to each other at least through a pair of end members (712 & 713) which themselves may comprise upper, lower and middle supports. (Note, although not shown in FIG. 7A or 7B, any number of pivotable beams may interconnect the side frame structures between the two end members (712 & 713). An example of a pivotable middle member 714 is shown, for example, in FIG. 7D.

Regardless of the number of beams interconnecting the side frame structures, each beam is pivotably connected at each end to a point on one of the two side frame structures. These pivotable beams are configured such that the frame structures may be configured as pairs of parallel frames (sides 702 & 703 and ends 712 & 713) disposed orthogonal to each other to form an interior volume 718 (as shown in FIGS. 7A and 7B) on which deliveries may be placed, or a series of stacked parallel elements (as shown in FIG. 7C).

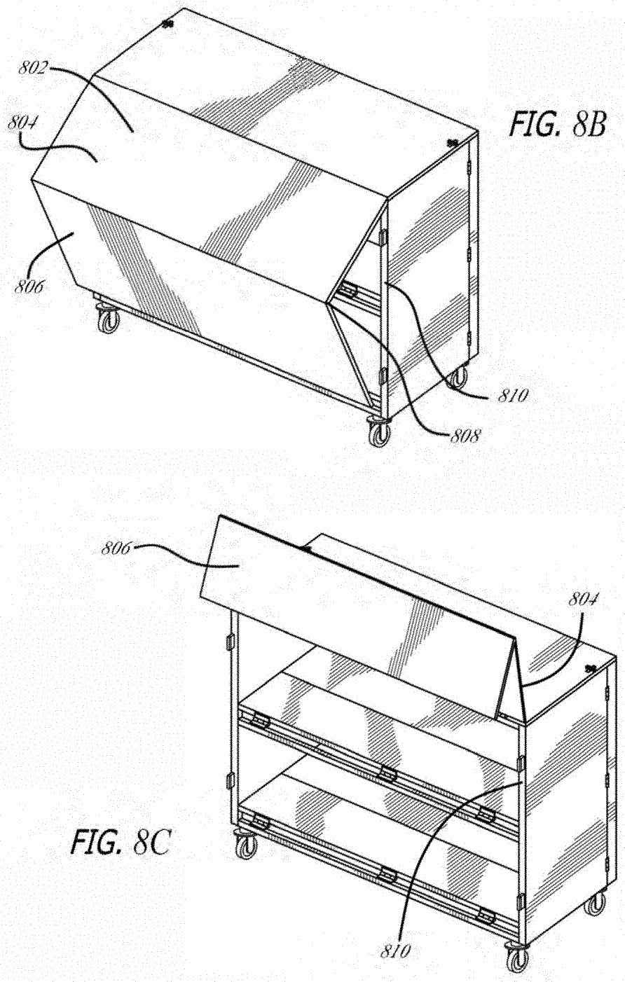

In various embodiments, as shown in the figures, the cart container further may either be open or comprise a series of walls configured to cover the side frame structures (702 & 703) and end members (712 & 703) to provide items stored within protection from the elements. Although the various walls may be unitary constructs, it should be understood that any of the walls may be formed of multiple portions of any desired length and height provided the walls cover the interior volume. These multiple portions may also be pivotable relative to each other such that the walls may be moved to expose the interior volume. An exemplary embodiment of such a compactible cart 800 is shown in FIGS. 8A to 8C. As shown, in some such embodiments the wall (in this example one of the side walls 802) is formed of upper 804 and lower 806 portions that are pivotably connected together by an adjoining connection 808. In numerous embodiments, the walls, whether unitary or segmented, may in turn be pivotably connected to the frame 810 by a pivoting connection device 812 such that the interior volume may be accessed.

In many embodiments at least one of the walls further comprises at least one handle 812, (as shown in FIG. 8A) disposed along a portion of a face thereof to assist in opening and closing the wall. In various embodiments, the panels may further comprise cooperative latches (814 & 816) that can be latched when the walls are disposed in an unfolded configuration to ensure the cart is stably fixed in place. In some such embodiments, at least one of the set of latches is disposed along the edges of the wall panels. In various embodiments, the latches may be chosen from the group consisting of hook and loop, buttons, snaps, zippers, etc.

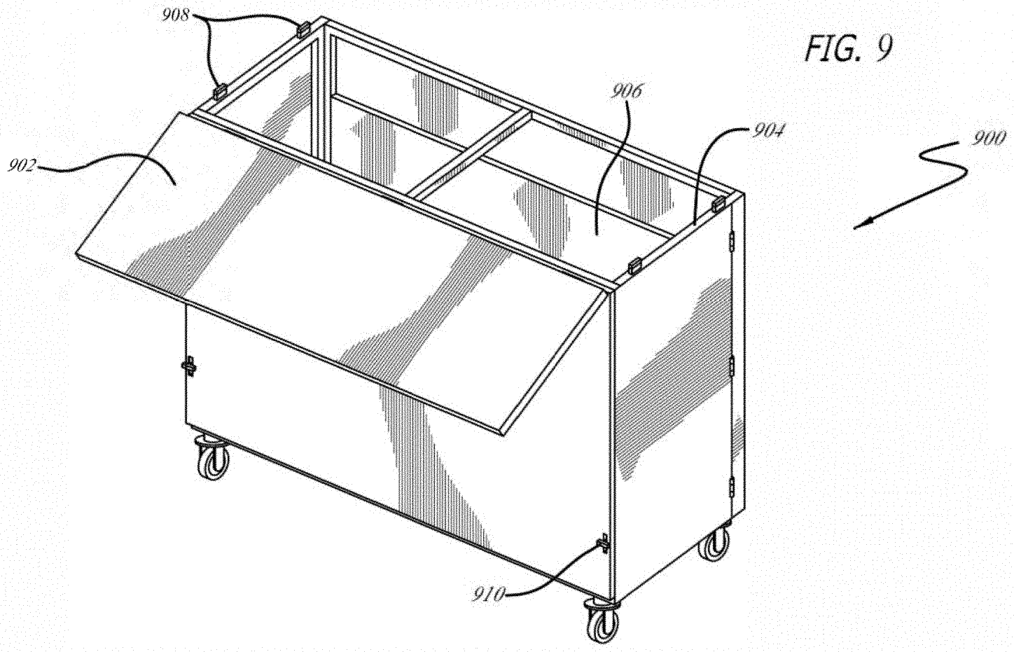

In some embodiments, more than one or all of the walls may be thus segmented and/or pivotable in relation to the frame of the cart. In various embodiments, as shown in FIG. 9, a top wall 902 of the cart 900 is pivotably connected to the top of the frame 904 such that the interior volume 906 of the cart may be accessed. In many such embodiments, the pivotable walls may be fixed into a closed position (as shown in any of FIG. 8A) through a series of latches 908 to prevent pivoting of the frame elements relative to each other. Similarly, the other pivotable walls may be fixed in place through a series of similar latches 910.

Regardless of the specific design of each wall, in many embodiments the walls of the compactible cart are each made of a rigid material and comprise one or more panels having one or more portions. In some embodiments, the sidewall panels may each be configured to span the length of the respective frame. In many such embodiments, when the sidewalls are fully extended each of the side wall panels span between their respective frame supports, and each of the foldable panels meet on each side of the care such that the combination of the wall panels completely surround and define the interior of the cart. In many embodiments, for each side or end wall of the cart, one or more panels is pivotably attached at least one of the frame beams and or one of the other walls.

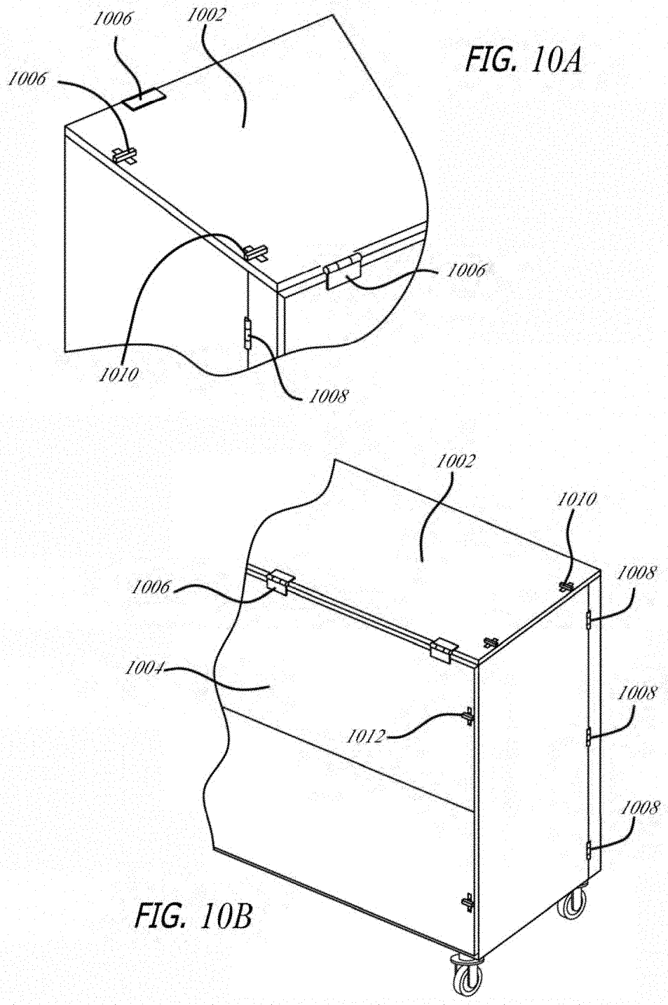

In one embodiment, as shown in FIGS. 10A and 10B, the top 1002 and at least one of the other side or end walls (e.g., 1004) are pivotably attached to each other through a hinge mechanism 1006 such that only one of either the top or side are capable of pivoting at the same time. For example, in various embodiments the front sidewall 1004 may be pivoted up to expose the inner volume only when the top wall 1002 is latched in place. In turn, the top wall 1002 is only pivotable when the sidewall 1004 is latched into place.

Although the walls are shown as being formed of either one or two panel portions, it should be understood that any number of panels and sections may be used such that the sidewalls are capable of spanning the distance between the front and rear walls, and foldable such that the inner volume may be accessed. Additionally, various embodiments may incorporate multiple pivoting mechanisms 1008 along the side walls that can allow the other sidewalls to pivot relative to the frame. Various embodiments may also incorporate latches (1010 &1012) that can connect or secure portions of the cart to the frame and/or other sidewalls. Although certain configurations of latches (1010 &1012) and pivot connections are illustrated, it should be understood that any combination and/or placement of the devices can be used.

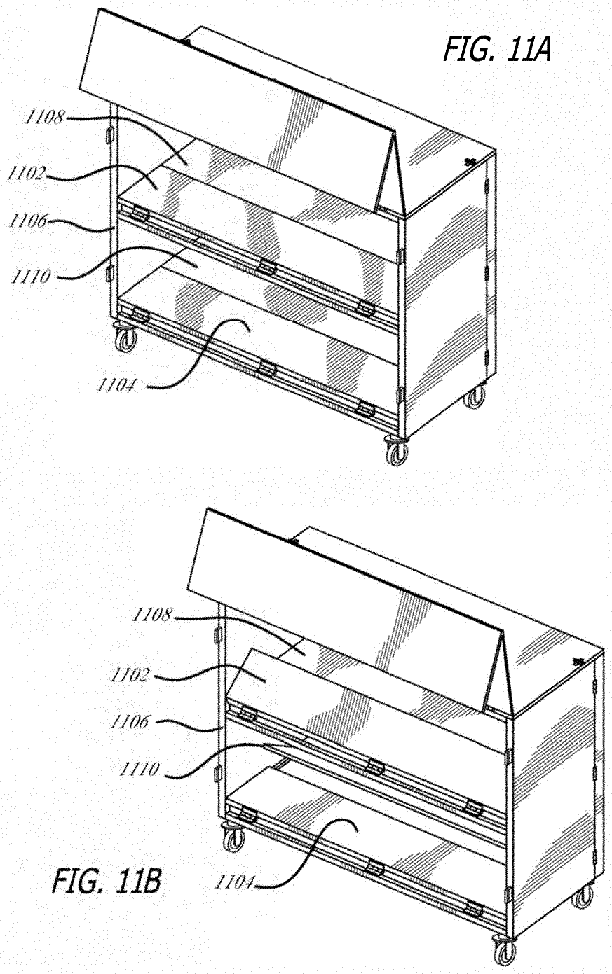

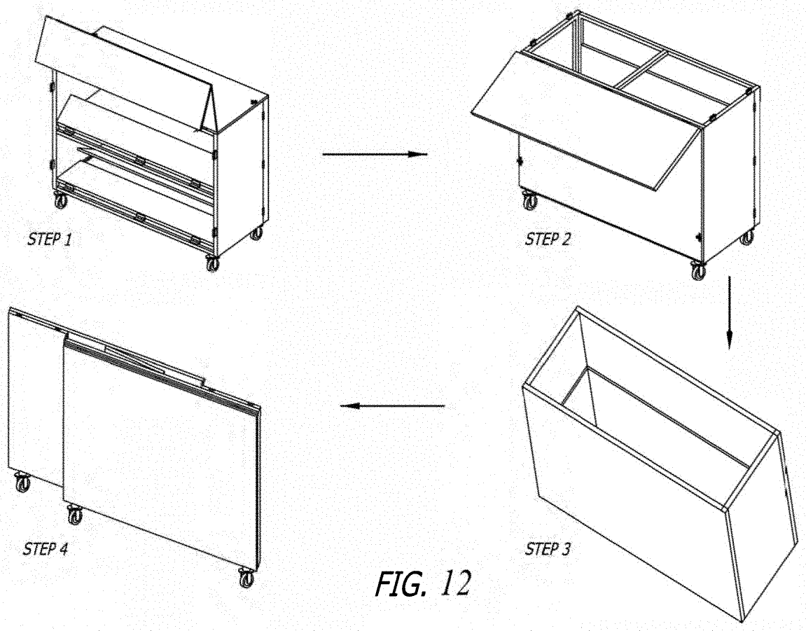

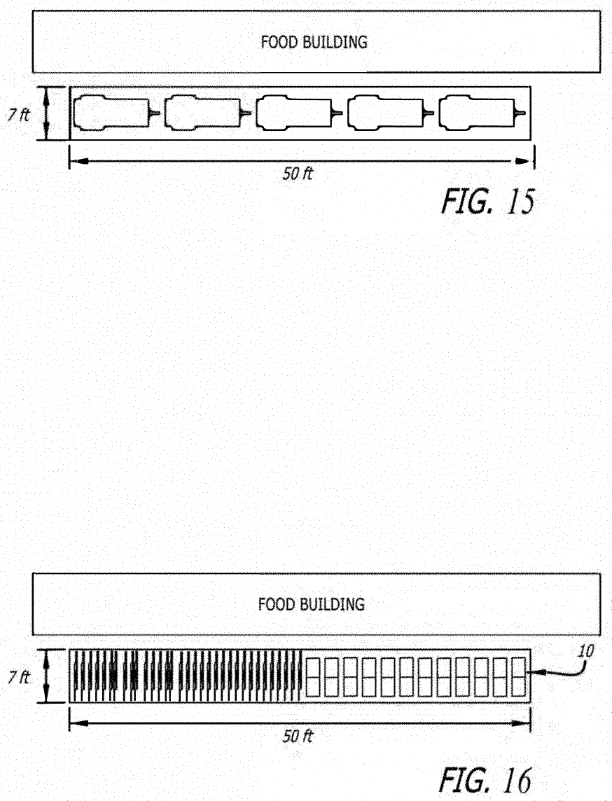

As shown in FIGS. 15A and 15B, in various embodiments the cart comprises a set of interior platforms (1102 & 1104) that are also pivotably connected to the frames 1106. In many such embodiments the interior platforms (1102 & 1104) are formed of multiple portions (1102 & 1108′ and 1104 & 1110) such that they may be pivoted relative to the walls of the cart to be positioned either parallel to the side walls of the cart or perpendicular to the side walls to form a set of horizontal platforms. In embodiments where pivotable middle members are present in the cart, the interior platforms may rest thereon to provide additional stability to the cart in the unfolded configuration. In many embodiments, the interior platforms are pivotable in at least a 90-degree arc outward away from the central point of the cart, thus folding the interior platforms against the sidewalls of the cart, as shown in FIG. 11B. Although two the interior platforms are shown in the figures, it will be understood that any number of interior platforms may be disposed within the inner volume of the cart. In addition, although the interior platforms are shown as pivotably interconnected with the sidewalls of the cart, it will be understood that the platforms may also be interconnected with the end walls.

Although two sets of two wheels are shown in the figures, it will be understood that any number of sets of wheels comprising any number of wheels may be disposed to provide stability to the wagon, and each of the sections of the wagon platform and provide it with the capability to move via rotary motion of the wheel sets. In many such embodiments, the rear and front sets of wheels are offset relative to each other by a sufficient amount to provide stability to the wagon. In some such embodiments, the sets of wheels are disposed proximal to opposite ends of the horizontal platform. In various such embodiments at least one pair of wheels may further comprise a handle mechanically interconnected thereto. In some such embodiments one or both of the sets of wheels are pivotable about an axis perpendicular to the longitudinal axis of the horizontal platform of the wagon, such that the direction of the sets of wheels may be controlled.

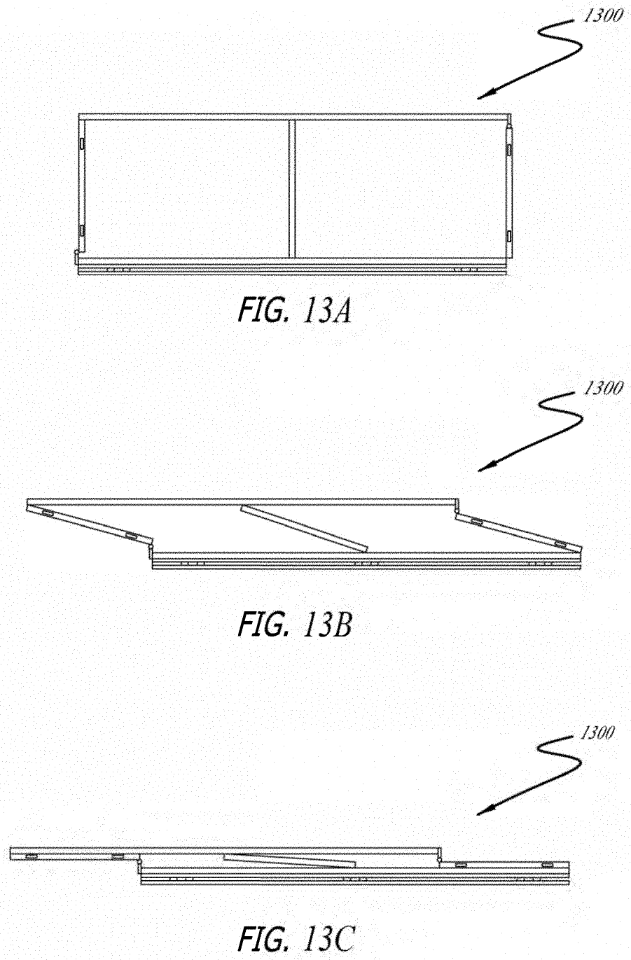

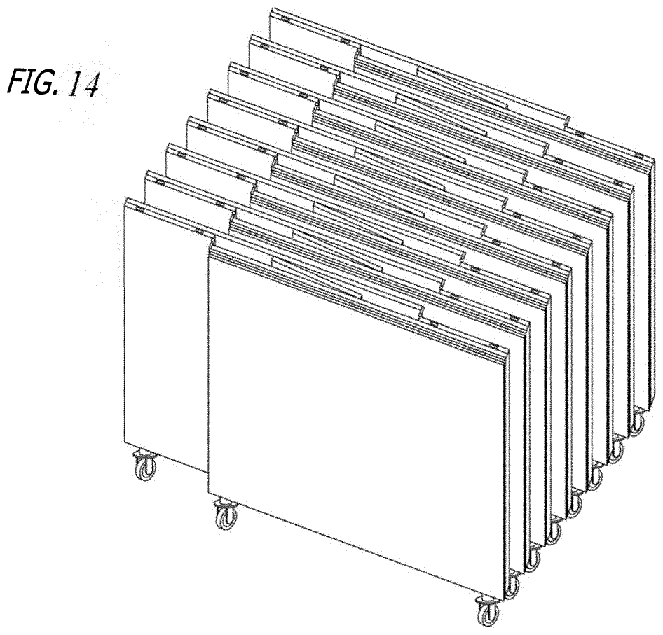

As shown in FIG. 12, in the various embodiments the frames and walls are all hinged or foldable relative to each other such that the frames/wall panels fold flat together and nest such that the frames/panels are all disposed parallel to each other when in a fully compacted configuration. In various embodiments, as shown in Step 1, the cart is readied for compaction by lifting the interior platforms from a disposition orthogonal to the walls (side and end) of the cart to a position parallel to the walls (side and end). In Step 2 the top wall (where present) is folded flat against the outer face of the sidewall. With the various portions of the cart spanning the side frames of the cart removed, as shown in Step 3, the various frames and walls of the cart are pivotable relative to each other such that they may be folded into a series of parallel planes (as shown in Step 4). A series of images showing this folding process from a top view of a cart 1300 are provided in FIGS. 13A to 13C.

Although not shown in the photos, to prevent the wagon from unfolding uncontrollably a retaining mechanism, such as a lock, clasp, or retaining strap may be incorporated into the cart to secure the frames and walls of the cart from moving relative to each other once locked.

Although many embodiments are described above in reference to FIGS. 7A to 13C, other embodiments may also be contemplated. For example, the walls may be detachable such that they can be removed from the sides of the wagon. In various embodiments, as shown, such hard walls may be detachably attached to the wagon via fasteners, such as, for example, snaps, buttons, zippers or hook & latch fasteners. Regardless of the specific construction of the compactible carts, according to embodiments, carts capable of such compaction allow for substantial space saving when stored next to each other, as shown, for example, in FIG. 14. As previously discussed, such stackability has significant operational implications for embodiments of delivery systems.

### Embodiments Implementing Compactible Haulers

Various embodiments also incorporate compactible haulers configured and sized to support a compatible container (e.g., container cart as previously described) having at least two operational configurations. In many such embodiments the compactible hauler has a first unfolded configuration where the hauler platform is configured in a single elongated horizontal plane, and at least a second compacted configuration where the hauler platform is disposed in two adjacent longitudinal planes disposed parallel to each other and where the interior platform is folded into a configuration parallel to the planes of the sidewalls, as discussed in more detail below.

The use of such compactible haulers addresses a second issues with conventional delivery systems. Distribution centers must preposition haulers along the street for loading of containers ready for delivery, as shown in FIG. 15. However, there is only a set amount of street front on which such trailers or haulers may be positioned. Accordingly, using conventional haulers and trailers allows for only a limited number to be positioned at any one time, and also doesn't allow for efficient use of the valuable street frontage for haulers being stored for later use. Compactible haulers according to embodiments allows for significantly more efficient use of the street frontage. As shown in FIG. 16, it is possible to store a vastly larger number of compactible haulers when not in use and then only unfold then for container loading when needed.

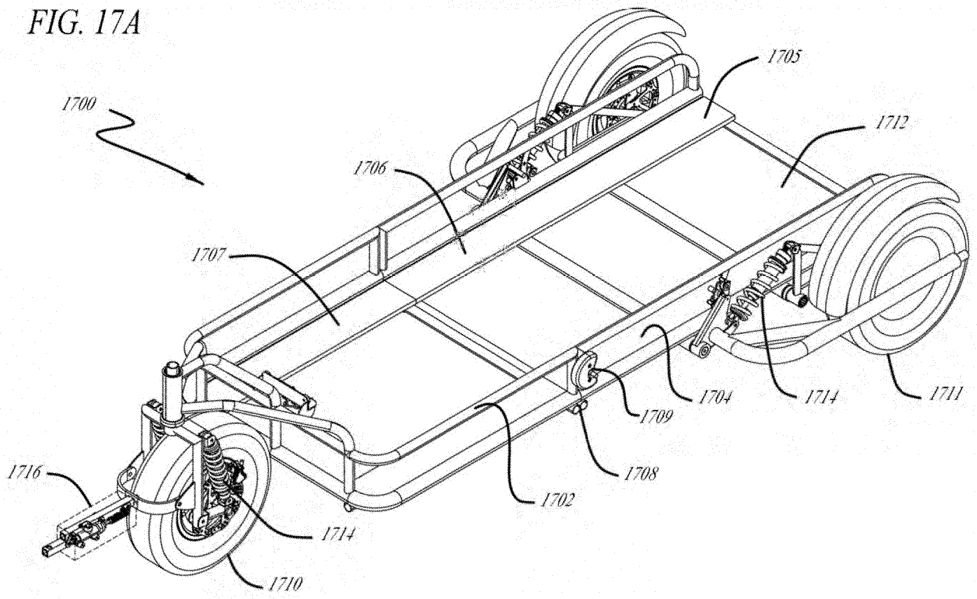

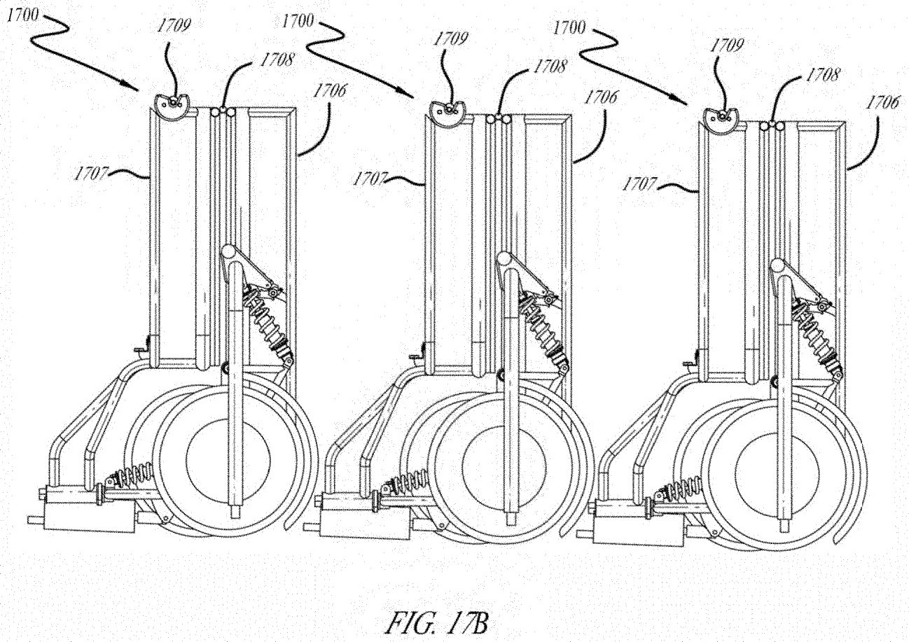

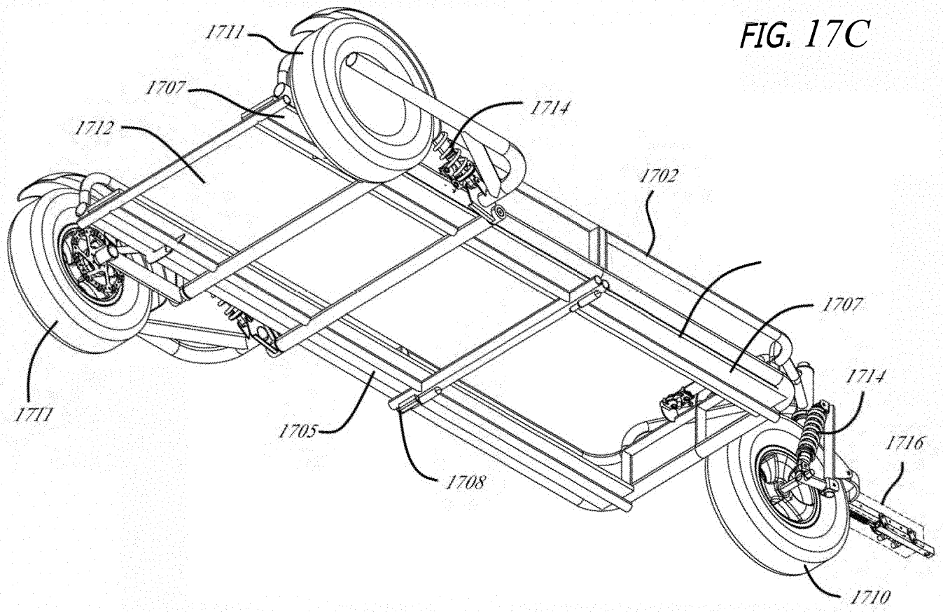

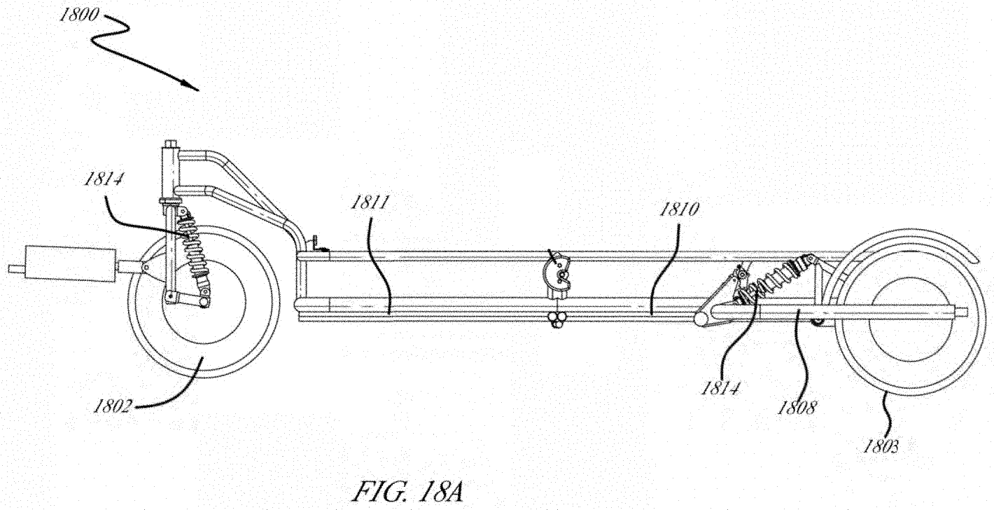

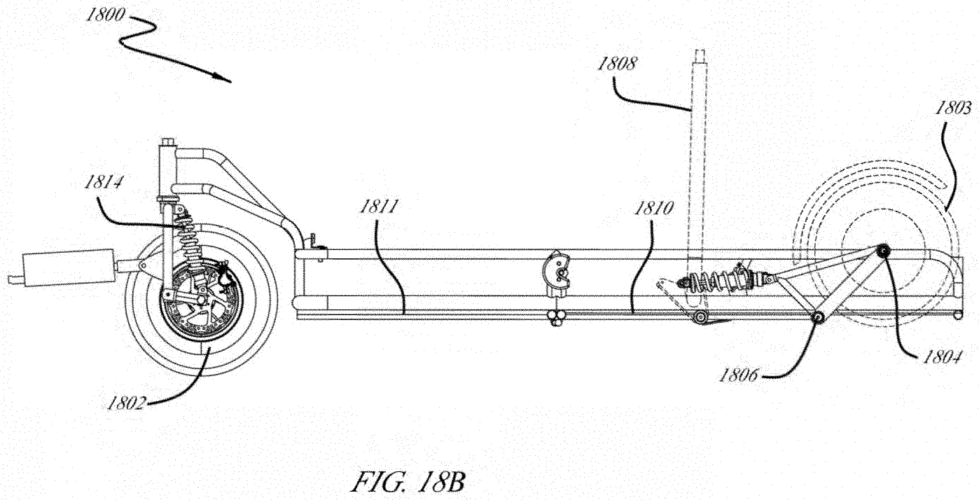

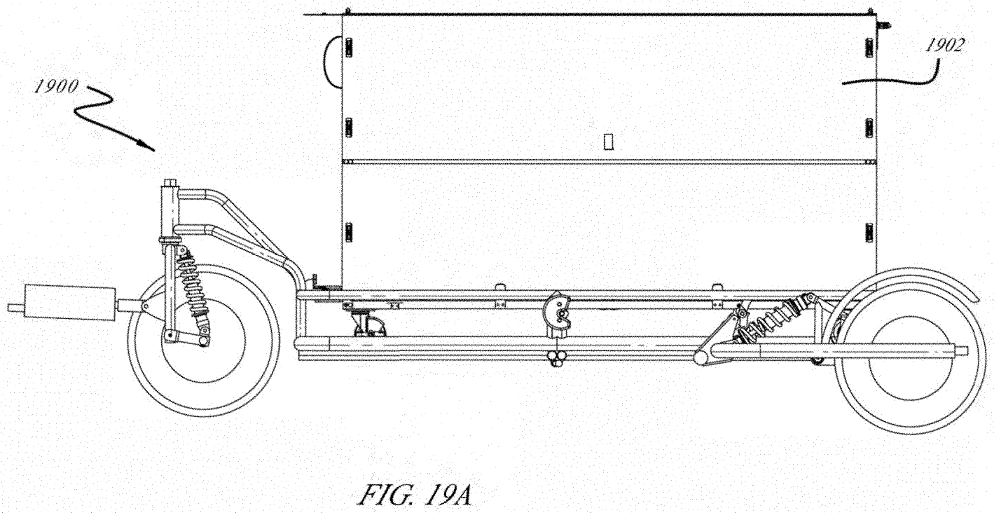

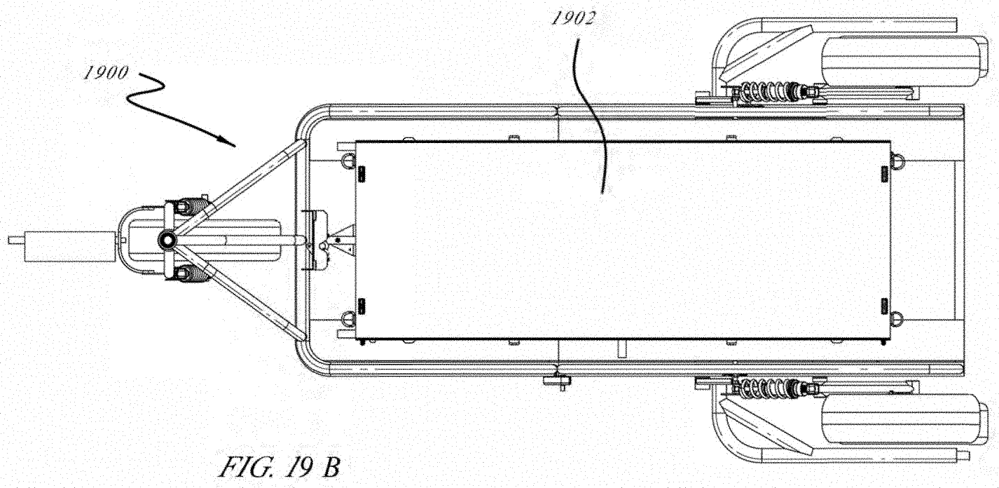

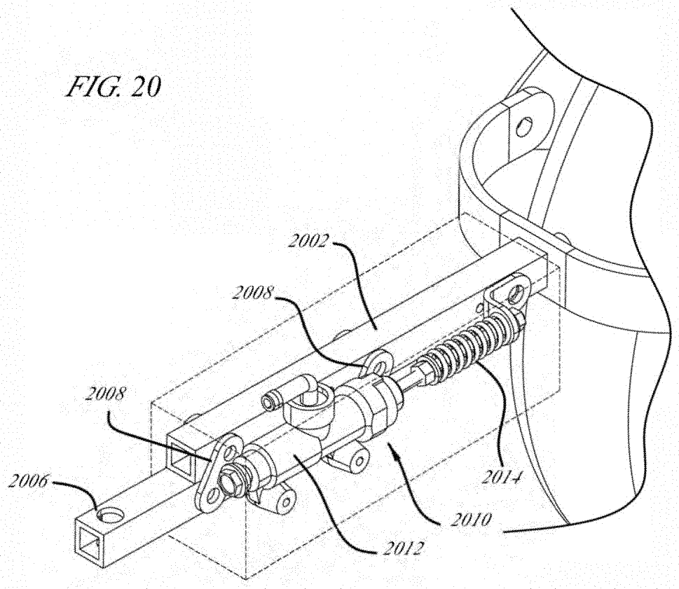

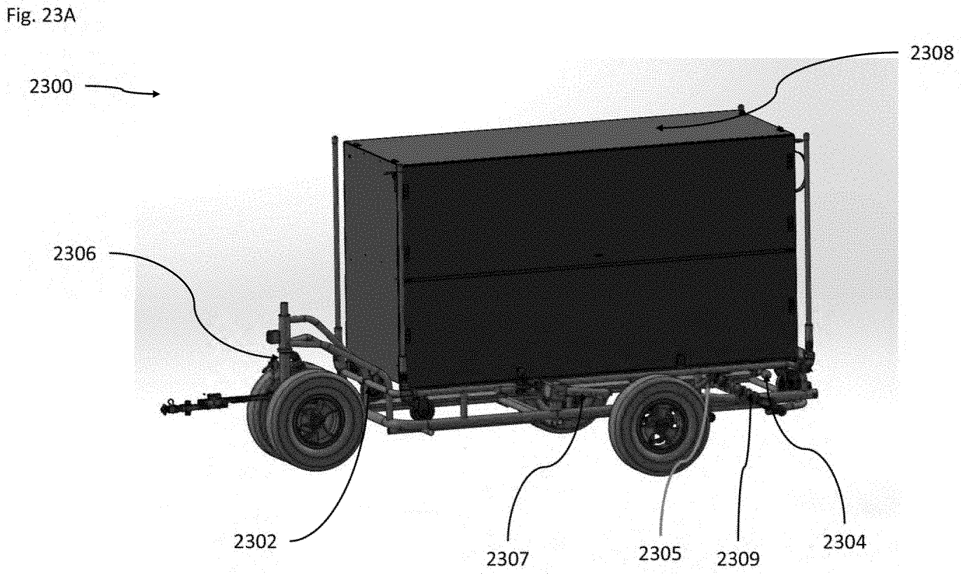

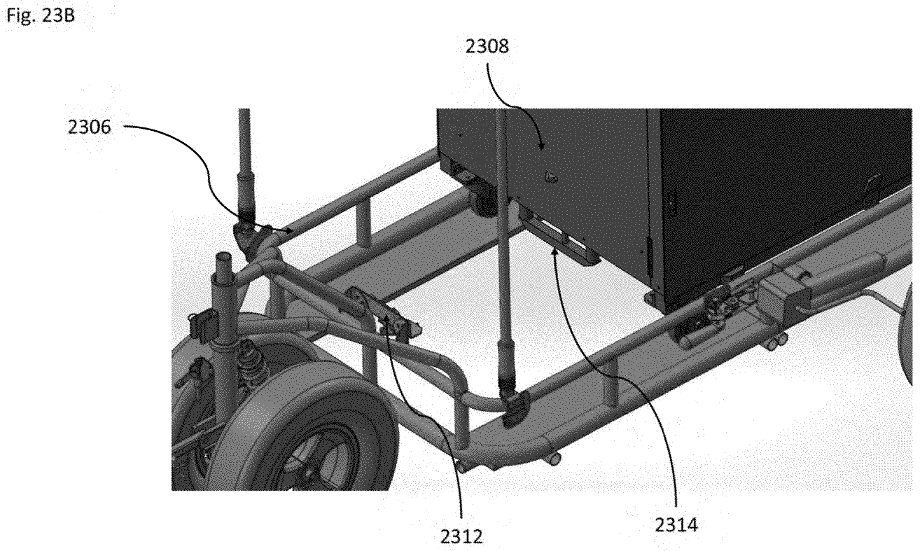

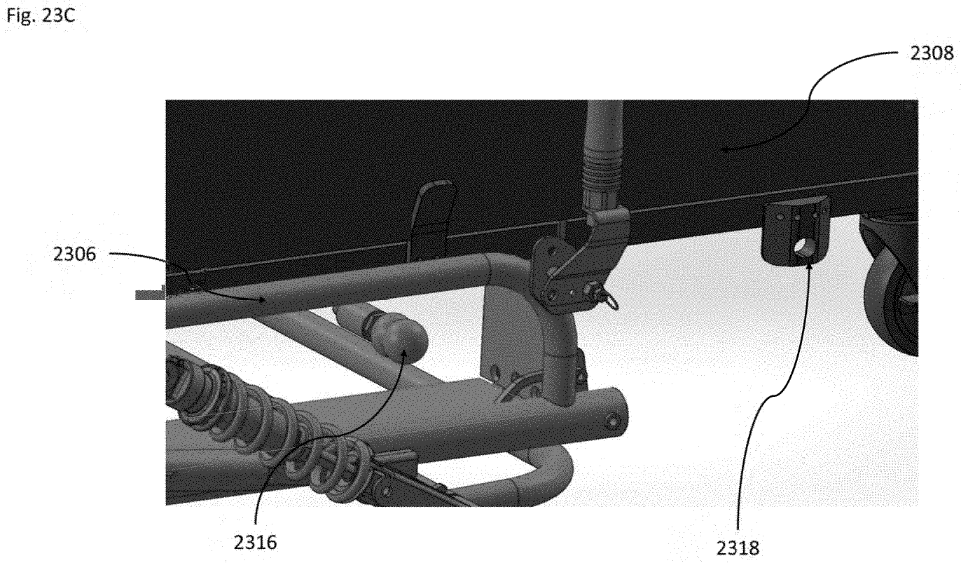

As shown in FIGS. 17A, 17B and 17C, in many embodiments' compactible haulers 1700 include a frame structure 1702 that supports a hauler platform 1704, that may be a solid sheet, or as shown tracks 1705 disposed on either inner side of the frame. For compactibility, the hauler platform is divided into at least two sections (1706 & 1707) interconnected by hinge joints 1708 that in many embodiments may be lockable 1709 to prevent unintended pivoting of the hauler platform during use. During operation this hinge may be unlocked and the two sections of the hauler platform may be allowed to pivot relative to each other such that each of the two sections lie in adjacent parallel planes to each other and the front 1710 and rear wheels 1711 overlap, with the front wheel 1710 extending through the open space 1712 formed between the tracks 1705 of the hauler platform (as shown in FIG. 17B). Although the hauler presented is shown as having three wheels interconnected with the frame structure, it will be understood that any suitable arrangement of supporting wheels capable of overlapping when in a compacted configuration may be used. As shown, such wheels may be interconnected to the frame structure with resilient members (i.e., springs, etc.) 1714 such that road bumps are dampened during use. As can be appreciated, the location of the resilient members 1714 can vary depending on the overall design and function of the trailer. For example, some embodiments may have the resilient member positioned forward of the rear wheels 1711 while other embodiments may locate them to the rear of the rear wheels 1711. This can be further illustrated in FIGS. 23A-23C where the resilient member is disposed rearward of the rear wheel.

The trailer/hauler may also incorporate an integrated hitch braking system 1716 attached proximate to the front wheel where the trailer would interconnect with the propulsion device to prevent the trailer from impacting the propulsion device during braking, as will be described in greater detail below. Using a compactible hauler, in accordance with embodiments, it is possible to stack a large number of compacted haulers in very limited space, as shown in FIG. 17B.

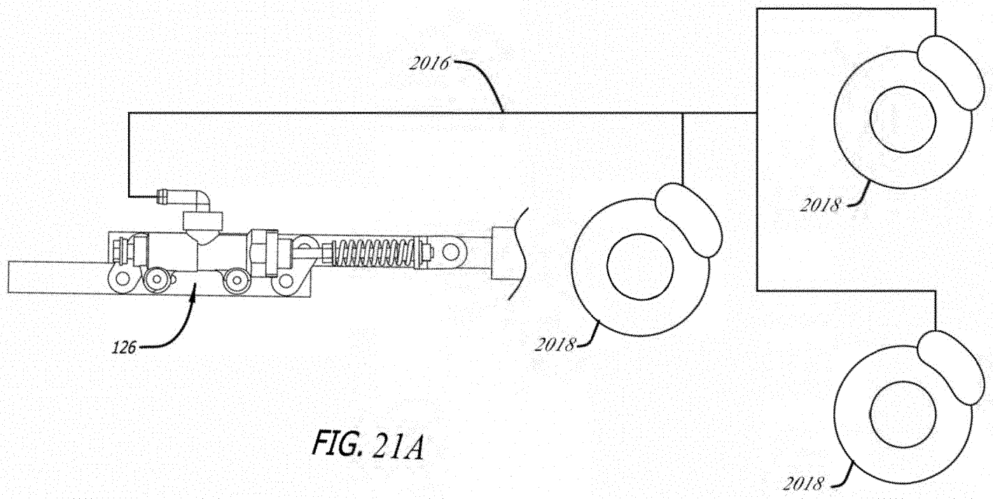

Turning to FIGS. 18A to 19B, in many embodiments the compactable hauler is also configured with a mechanism that can allow the hauler 1800 to pivot such that the portion proximate to the front wheel 1802 is disposed higher than the portion proximate the rear wheels 1803, and such that the portion proximate the rear wheels is positioned close enough to the ground to serve as a ramp structure for rolling container carts from the ground onto the hauler. In embodiments including such a ramp mechanism, the hauler 1800 further comprises a pivotably mounted rear wheel axle 1804 further pivotably interconnected with a frame 1806 and a suitable deployment mechanism, such as, for example, a handle 1808. In various embodiments (as shown in FIGS. 18A & 18B), this combination of pivoting members is configured such that rotation of the handle results in a linked pivoting of the axle and rear portion 1810 of the hauler platform from a first position where the pivot point 1804 of the rear wheel 1803 is in-line with the horizontal plane 1811 of the portion of hauler platform, as shown in FIG. 18A, to a second position where the center point of the rear wheel 1803 is extended above the plane of the rear portion of the hauler platform 1810, as shown in FIG. 18B. As can be appreciated the deployment mechanism can be any device that is capable of deploying or operating the movement of the hauler between the various positions. In some such embodiments the linkage between at least one of the pivoting members (e.g., handle and axle) are interconnected through the resilient member 1814 such that there is an inherent locking of the axle into position during operation in either the lowered or raised positions. Additionally, as previously described with respect to FIGS. 17A-17C, deployment mechanisms and linkages, such as the resilient member 1714, can be positioned in a number of different locations to allow for the movement of the hauler platform between the different positions. This can be further illustrated in FIGS. 23A-23C where the resilient member is disposed rearward of the rear wheel. As can be appreciated, utilizing such a ramp mechanism on a trailer or cart 1900 can make it is possible to easily roll a wheeled container cart 1902 in accordance with embodiments onto the compactable hauler 1900 for transport, (as shown in FIGS. 19A & 19B).

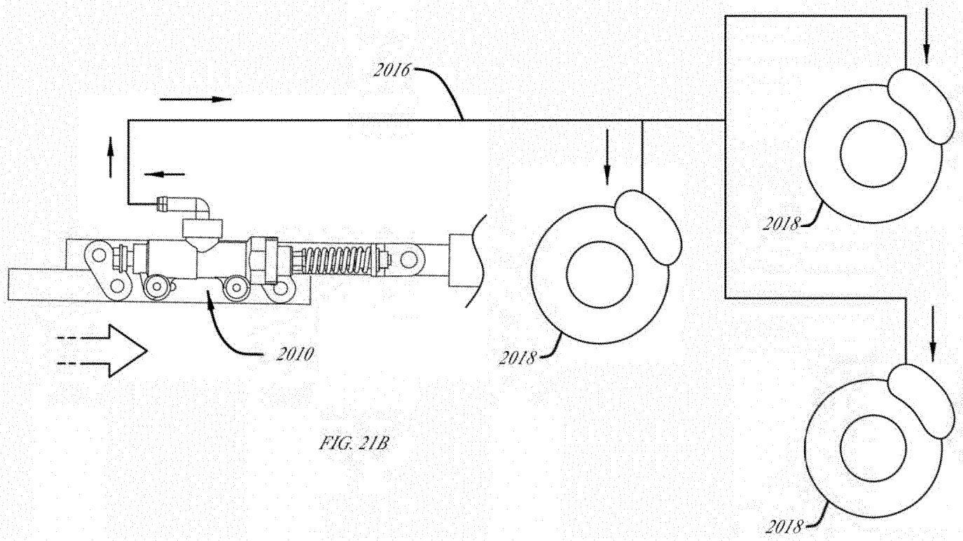

Some embodiments can include an integrated hauler braking mechanism, as shown in exemplary form in FIGS. 20 to 21B. As shown in FIG. 20, in an exemplary embodiment such a braking mechanism 2000 may include a number of different components. For example, the braking mechanism 2000 may be configured to be interconnected through a first support member 2001 attached to a hauler 2004 and through a second support member 2006 to the propulsion device (e.g., through a conventional hitch mechanism) which are pivotably interconnected via at least one hinge 2008. In many such embodiments, the surge braking mechanism comprises a pneumatic brake 2010 fixedly connected to the second support member at a first end 2012 (e.g., where the pneumatic cylinder is disposed) and fixedly connected to the first support member 2002 at a second end 2014 (e.g., where a resilient member is disposed) which is slidingly engaged into the pneumatic cylinder such that as the first and second support members move relative to each other the resilient second end 2014 of the pneumatic brake 2010 slides into and out of the pneumatic cylinder 2012 thereby generating and relieving pressure in the relevant brake lines 2016 interconnected with the wheels 2018 of the hauler. Of note, many embodiments of the surge braking mechanism replace the conventional design sliding relationship between support members with a pivoting action (as shown in FIGS. 21A & 21B) thereby creating a more robust braking mechanism that is much less susceptible to jamming.

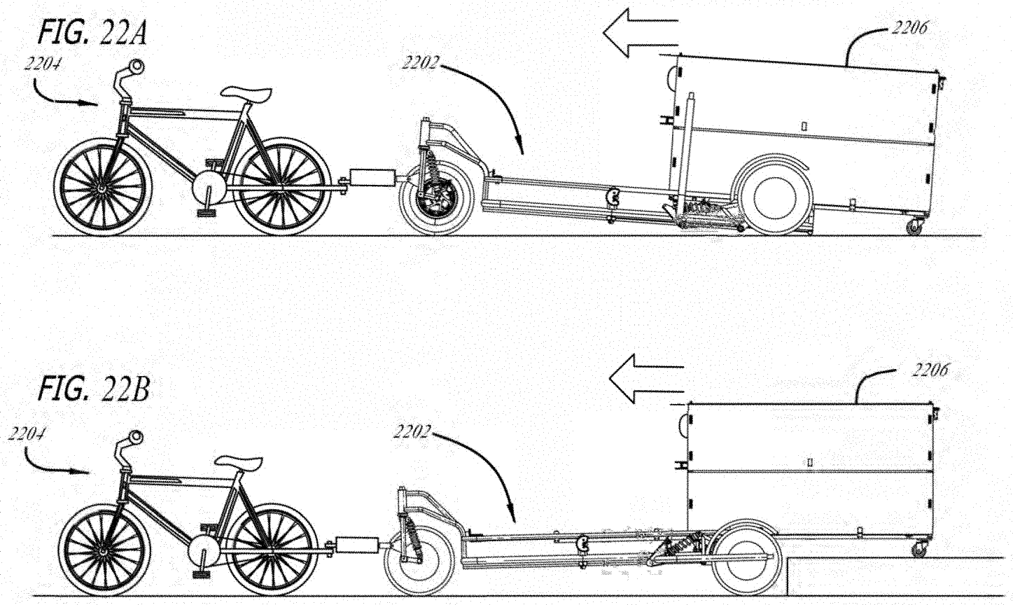

As previously discussed, a hauler in accordance with various embodiments, may be equipped with a kneeling mechanism that allows for loading of the hauler in two different modes, as shown in FIGS. 22A and 22B. The hauler 2202 may be connected to a propulsion mechanism 2204 such as a bicycle for example. Accordingly, there may be a need to have the hauler 2202 accept or load and unload cargo 2206. In some embodiments, the hauler platform can be lowered such that the hauler acts as a ramp, where containers may be loaded from the ground (FIG. 22A). Likewise, the hauler platform 2202 may remain in a position level with the center of the wheels, the hauler may be configured such that loading straight from a curb or other raised platform can be accomplished (FIG. 22B).

As shown in FIGS. 23A to 23C, in many embodiments the compactible hauler and compactible container may also incorporate one or more cooperative locking mechanisms. For example, FIG. 23 A illustrates a compactible hauler/container combination 2300 that is configured with a number of different locking mechanisms (2302 and 2304) positioned at different locations. The locking mechanisms (2302 and 2304) can be a two-part system where a portion of the locking device is on the trailer 2306 and a corresponding portion is on the container 2308. The use of locking mechanisms can help to secure a load or container 2308 of cargo on the trailer element 2306 for a more secure method of transport.

Additionally, it can be appreciated that trailer systems such as those illustrated in FIGS. 23A-23C can have a number of different control mechanisms to help control the movement of the trailer 2306. For example, similar to embodiments illustrated in FIGS. 17A-17C, some embodiments may utilize pivot control system that can allow the trailer 2306 to pivot or raise and lower at one end. The control system may be comprised of various elements such as a set of pivoting structures 2305 that are interconnected at one or more pivot points and are subsequently connected to a frame of the trailer 2306. The pivoting structures can be controlled with a lever or handle 2307 or any other suitable control device that will engage or disengage the pivoting elements 2305 in such a way that will lower or raise the back portion of the trailer. Additional embodiments, may be configured with a resilient element 2309 that can provide a resilient force on the pivoting elements 2305 to hold them in place. Other embodiments may also use locking mechanisms to hold the position of the trailer. As can be fully appreciated, the pivoting elements 2305, and lever 2307 can be place in any suitable location on the trailer 2306.

FIG. 23B illustrates an exemplary embodiment of a hauler/container combination 2300 where the container 2308 is being positioned onto the trailer 2306. At the front end of the trailer 2310 a self-closing latch 2312 is located and is configured to engage with a latch pin 2314 located on the container 2308. As can be appreciated, the self-closing latch 2312 will close and lock the container 2306 in place once it has been engaged or connected with the latch pin 2314 of the container 2306. To further secure the container 2306 in position on the hauler 2308, retractable pins 2316 may be positioned at the rear of the hauler configured to engage cooperative pin receptor 2318 disposed on the container 2306, as shown in FIG. 23C. By use of such locking mechanisms, the container 2306 can be secured within the hauler 2308 during transport and released therefrom once the hauler arrives at the offload destination.

Although one particular embodiment of a compactible hauler is shown herein, it will be understood that other elements of delivery system embodiments may be incorporated with other haulers, including other conventional haulers and compactible haulers, such as, for example, as described in U.S. Pat. No. 10,214,230, the disclosure of which is incorporated herein by reference.

### Embodiments Implementing Propulsion Devices

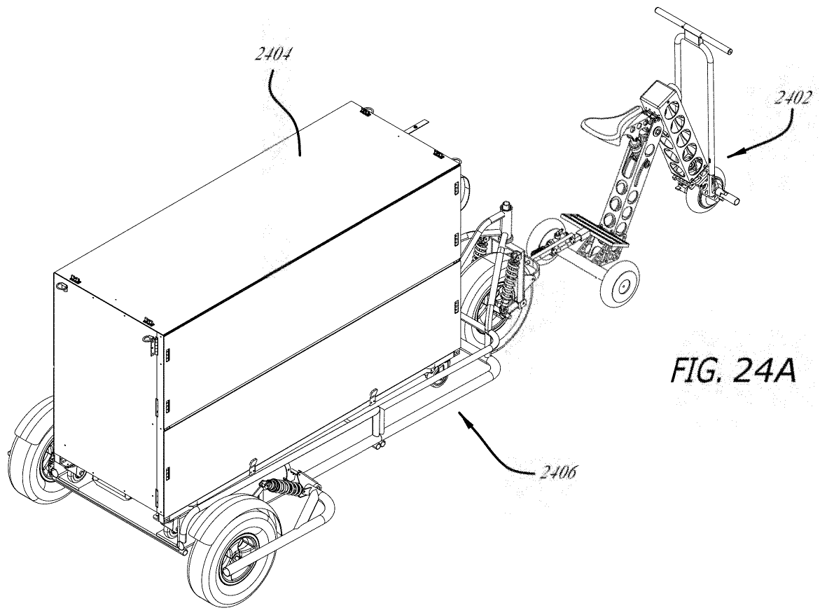

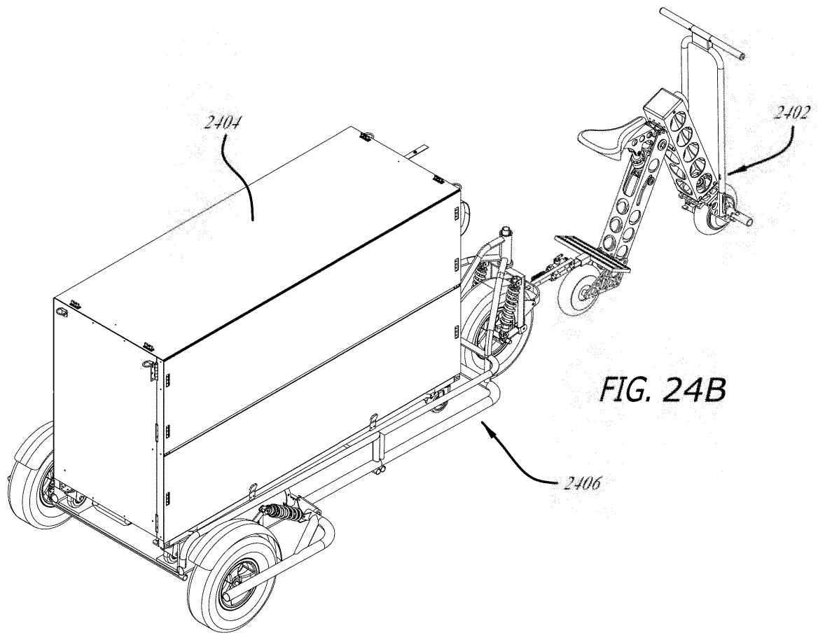

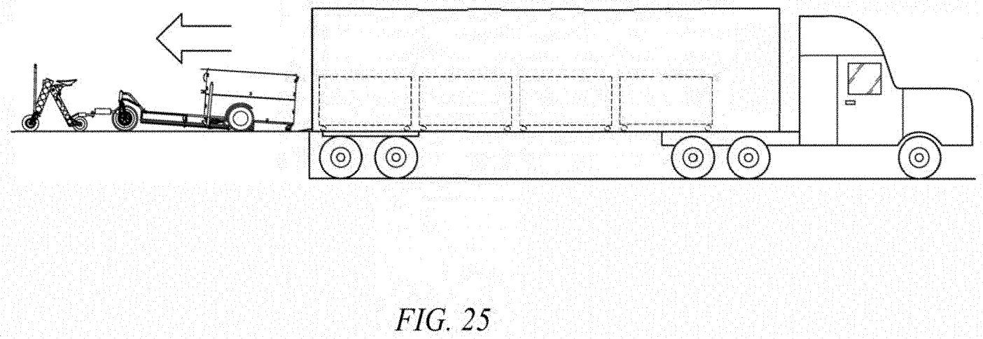

As previously described, embodiments of cart containers and haulers may be used with any suitable propulsion device including, bicycles, e-bikes, rickshaws, motorized vehicles, etc. In many embodiments, the propulsion device 2402 used in conjunction with the container 2404 and hauler 2406 itself may take the form of an electric scooter 144, as shown in FIGS. 24A and 24B. In some such embodiments the electric scooter itself could be compactible thereby further reducing the spatial footprint of the overall delivery system. (See, e.g., U.S. Pat. Nos. 9,227,687; 9,694,868; 9,873,476; the disclosures of each of which are incorporated herein by reference.) Integrated together elements of delivery systems may be combined to provide a complete solution to delivery from truck to hauler to customer, as shown in FIG. 25.

### Embodiments Implementing Location Systems

As previously described, embodiments of modular delivery systems may include propulsion systems, trailers/haulers and cart/containers that may be interconnected and interchanged in a variety of configurations. A challenge arises in determining and keeping track of the location, usage and maintenance records for all of the assets of such an interchangeable and modular delivery system. One solution would be to attach location electronics (such as, for example, GPS units) on every asset in the system. However, aside from the hardware cost for each of the tracker hardware elements, such a system incurs ongoing cost for cellular data transmission to the cloud and requires a power supply for each tracker.

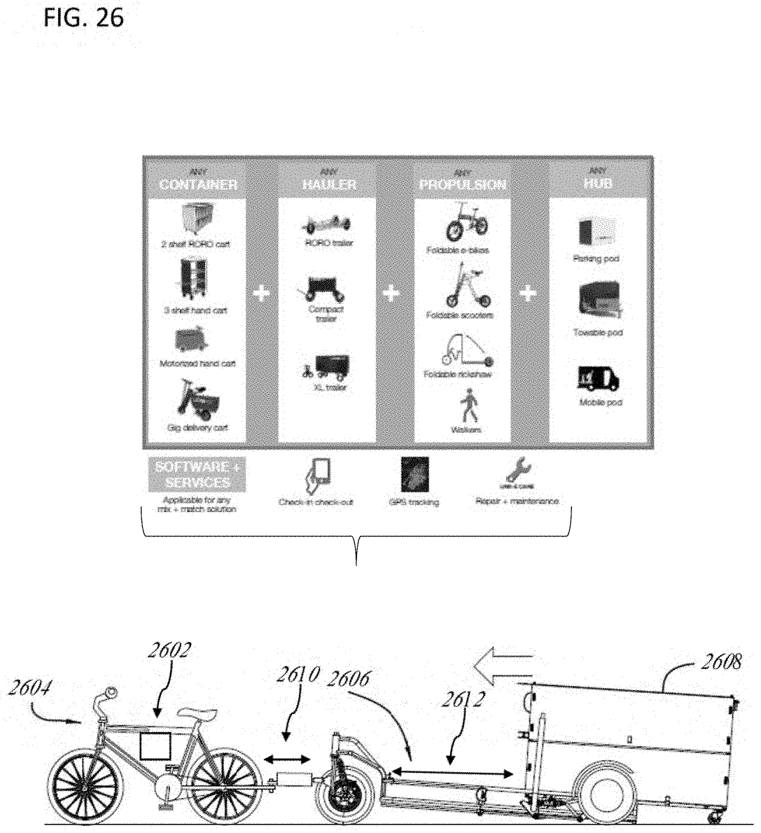

Many embodiments of the modular delivery system implement a modular location system that allows for a location electronic on a single element of the system to activate and record activity across all elements of the system that are interconnected together. One exemplary embodiment of such a system is provided in FIG. 26. As shown, in some such embodiments, an electronic location unit 2602 (such as, for example, a GPS or other suitable location system) is implemented on one element of the modular delivery system. Although in the exemplary embodiment the location unit 2602 is collocated on the propulsion unit 2604 and advantageously shares a power supply with the propulsion unit, it will be understood that this unit may be located on any of the units including the hauler 2606 or container 2608, and the power supply may be either collocated with the location unit or positioned elsewhere on the system.

Regardless of the positioning of the location unit and/or power supply among the elements of the modular delivery system, each of the units are provided with a suitable electrical connector that engages when the units are interconnected. For example, a suitable electrical interconnector 2610 providing power and signal transmission may be integrated with the connecter between the propulsion unit and trailer described previously. Similarly, an electric interconnector 2612 providing power and signal transmission may be integrated with the container latch as described with reference to FIGS. 23A to 23C. Each element of the delivery system may then be supplied with an internal reference that uniquely identifies the asset such that when interconnected the location unit records not just information on the individual element on which it is installed, but also records information for the interconnected secondary elements. Note, that though the system contemplates both a secondary (hauler) and tertiary (container) interconnected units, such a system could be designed only to record the interconnection of the hauler should information on the container be deemed unnecessary.

Regardless of the specific architecture of the system, the location unit may be configured to record and transmit location, speed and accumulated mileage information, either locally, or to a cloud database. Other information on weight of the container installed on the hauler, etc. may also be included by the installation of additional suitable sensor systems. During operation, mileage accumulation, and other data, can be obtained by electronically marrying the trailer/hauler and the cart/container (or one of them) to the propulsion unit during the check-out process of the equipment. After the user checks the equipment out, every mile accumulated on the propulsion unit will be added in a database to the accumulated mileage of the married trailer and cart. When the user checks the equipment back into the pool, that link will be broken and the trailer and cart are ready to be remarried to another propulsion unit.

### Embodiments Implementing Illuminated Masts

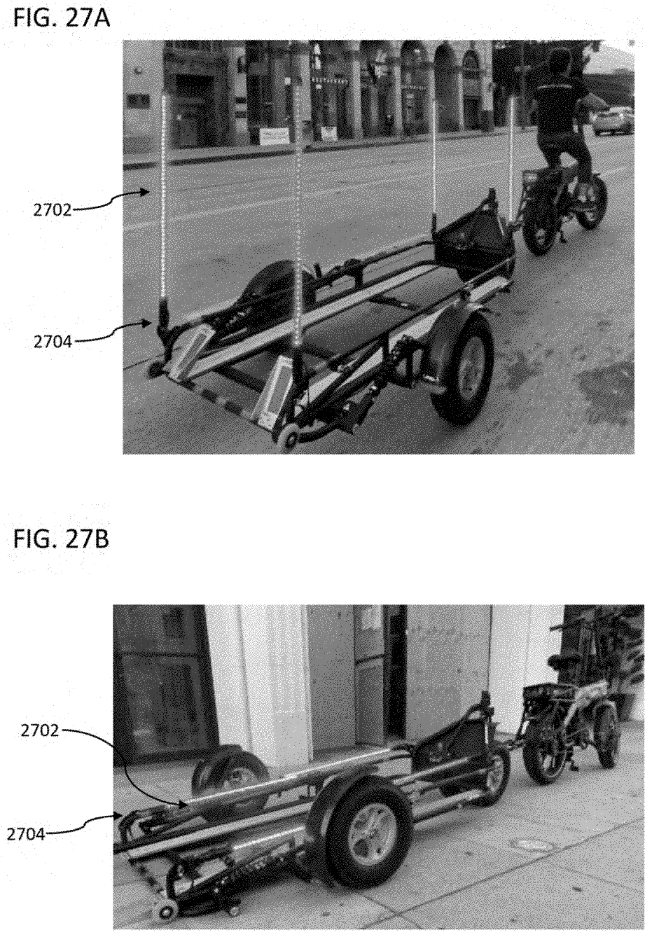

As previously described, embodiments of modular delivery systems may include certain electrical components, such as location units. In many embodiments, such electrical components may include lighting elements implemented on the hauler or container. Although these may include conventional brake and running lights, in many embodiments the light elements include a plurality of elongated illuminated masts that in combination create a high-profile visual line of the hauler and/or container. Exemplary embodiments of such light elements are provided in FIGS. 27A to 29, as discussed below.

One principal hazard of operating low-profile trailers (e.g., trailers that have a height below eye-level or five feet), such as those proposed for use in the modular delivery system of current embodiments, is that they can easily be overlooked by operators of larger vehicles leading to collisions. One solution to this is to create a rigid framework that extends the profile of vehicle vertically. Such frameworks add to the weight and bulk of the trailer and would make compactibility impossible.

As shown in FIGS. 27A and 27B, various embodiments of trailers in this disclosure implement a set of deployable illuminated masts 2702 that extend above the plane of the trailer to a height suitable to create a virtual high-profile frame describing the boundaries of the trailer/hauler (e.g., at least twice the height of the plane of the trailer). As further shown, in some embodiments these illuminated masts may be further attached to a set of pivotable holders 2704 that can pivot the illuminated masts 16 from an upright configuration normal to and extended above the plane of the trailer/hauler to a position collapsed against and along the plane of the trailer/hauler.

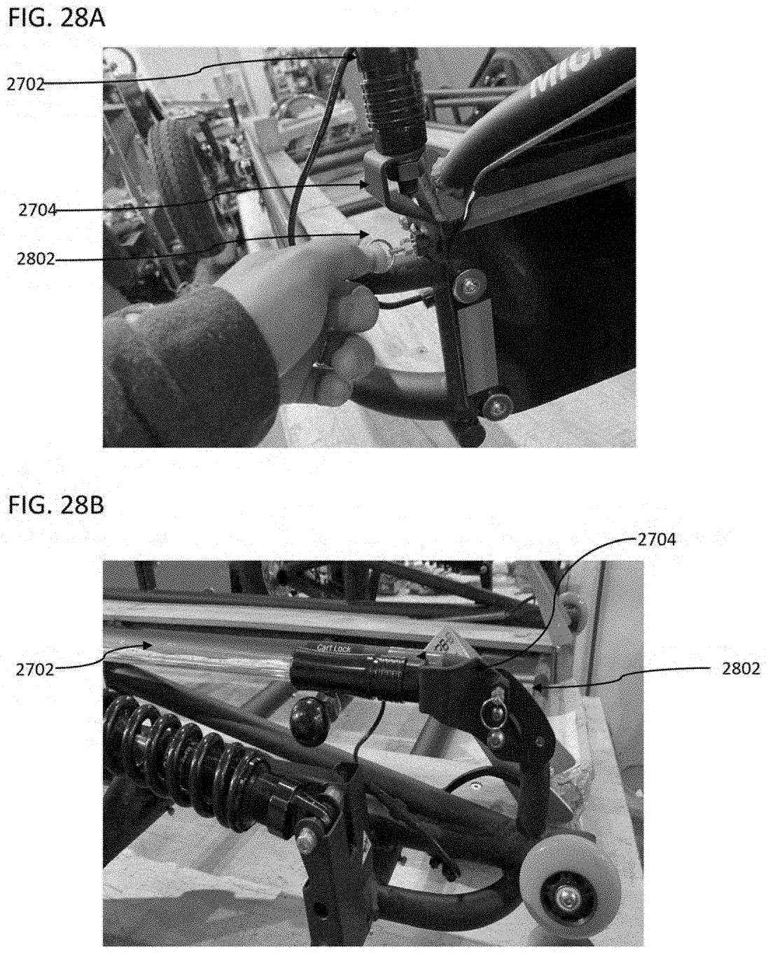

Although any pivotable holder 2704 may be used, in various embodiments, as shown in FIGS. 28A and 28B, the pivotable holder is configured to interconnect with the illuminated mast 2702 and pivotably connect through a lockable hinge mechanism 2802 to the frame of the trailer/hauler. In such embodiments, the locking mechanism may include a pin that engages and disengages to allow for the pivoting of the hinge and the folding of the illuminated mast.

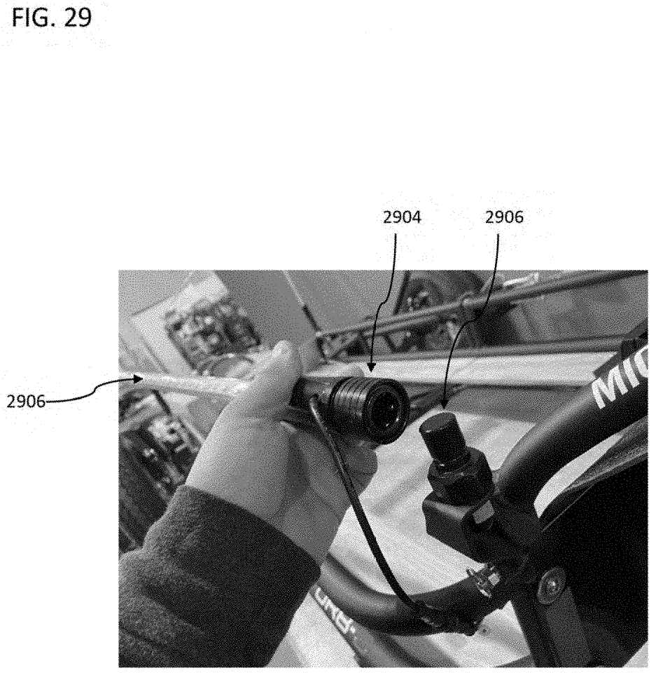

As shown in FIG. 29, the illuminated mast may also be connected to the pivotable holder via a connector 2904 that allows for the quick removal of the illuminated mast 2702 from the pivotable holder. In various embodiments the connector comprises a lockable pin 2906 and socket 2904 mechanism by which the illuminated mast 2906 can be quickly and easily connected and disconnected to the frame of the trailer/hauler. Note, although in the embodiment shown the wire is external to the illuminated mast and connector, in various embodiments, the electrical connection between the two may be integrated such that the physical connection of the mast to the holder initiates electrical contact between the two.

Although not shown, it will be understood that electrical power to power the illuminated masts may be supplied either in the hauler./trailer itself or, as described above, may be supplied via a connection between the trailer/hauler and the propulsion unit. It will also be understood that the mast may be illuminated using any suitable configuration of illumination elements, such as a single illumination source or a plurality of illumination sources, such as are depicted in the figures.

### Embodiments Implementing Trailering Connection Systems

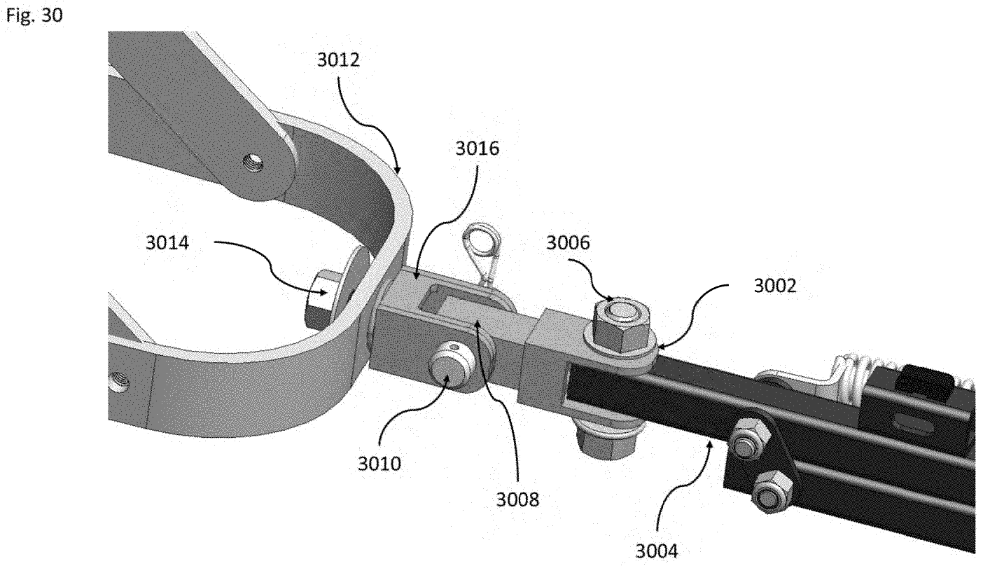

Turning to FIG. 30, an embodiment of a multiaxial trailer hitch system 3000 is provided. As can be appreciated, many embodiments of the various trailering and propulsion systems can implement embodiments of a multiaxial trailer system. In the exemplary embodiment shown, a first end 3002 configured to connect with a trailer 3004 is configured to rotate about a first “z” axis at a first pivot point 3006. Such that elements connected to the “z” axis pivot point 3006 may freely move in a horizontal plane. A second end 3008 is configured to rotate about a second “y” axis at a “y” axis pivot point 3010. Such elements connected thereto may move in a vertical plane. In various embodiments, the first end is connected to a trailer or hauler 3004, and the second end is connected to a propulsion system (not shown). In some embodiments, the multiaxial trailer hitch system 3000 can have a propulsion system connection device 3012. The connection device 3012 can be any form such as a bracket or assembly that interfaces with the propulsion device in any number of ways. The connection device 3012 can rotationally connect to the trailering system via an “x” axis pivot point 3014. The “x” axis pivot point 3014 can correspond to or be a part of a connection bracket 3016 that interfaces with or connects to the first end 3002 of the system as well as the propulsion system connection device 3012. Accordingly, the “x” axis pivot point and corresponding connection bracket can allow for “x” axis rotation of the system. It can be fully appreciated that embodiments of the multiaxial trailer hitch system can allow for multiple degrees of freedom of movement of the trailer element 3004 which can improve the movement of the trailer element 3004 during transport. Additionally, it should be understood that the directions and elements of the system 3000 can be reversed if desired. This can be done by the removal of one or more connection pins and/or elements that sit between the various components of the system.

### Embodiments of a Trailering Maneuvering System

The movement of a trailer or hauler can often times be difficult, especially when trying to move the trailer or hauler in a rearward direction. It often requires a counterintuitive movement of the vehicle itself in order to properly direct the rearward movement of the trailer. Much of this is due to the dynamics of the vehicle used to tow the trailer and the fact that all of the wheels traditionally remain in contact with the ground during the rearward movement of the trailer. For example, often the left movement of vehicle can result in the right movement of the trailer. This can make it difficult to back up and maneuver the trailer.

Embodiments of a trailering maneuvering system described herein can improve the maneuverability of the vehicle and/or trailer by disconnecting the rear wheels of the towing vehicle from the ground allowing for a single point of contact between the ground and the front wheel of the vehicle. This can be done through the deployment of a device that connects to the rear portion of a vehicle and is positioned such that the rear wheel or wheels of the vehicle are lifted off of the ground. In many embodiments, the device as engaged allows the rear portion of the vehicle to move in any number of directions.

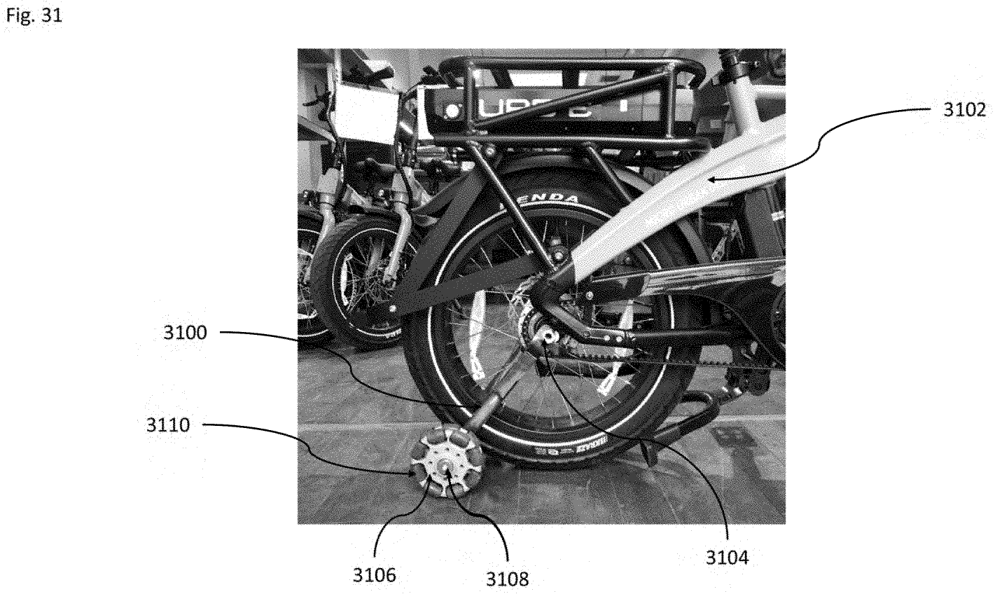

An exemplary embodiment of a maneuvering devise can be seen in FIG. 31. The exemplary embodiments illustrate a vehicle maneuverability device 3100 rotatably connected to a vehicle frame 3102. In many embodiments, the device 3100 can be connected to the vehicle at the rear axle 3104 such that the interface is easily configurable to rotate between different positions. In many embodiments, the device is configured with two wheels 3106 that are connected to the device on an axle 3108 that allows the wheels 3106 to rotate forward and backward. In a number of many embodiments, the wheels may be omnidirectional wheel. An omnidirectional wheel as described herein is any wheel type device that can allow for movement in any direction. For example, a Mecanum wheel that has a number of different rollers 3110 positioned circumferentially around a main wheel body. The omnidirectional wheel illustrated in the various embodiments herein illustrates a small sample of one type of omnidirectional wheel. It should be understood that many embodiments may use any number of omnidirectional wheels to allow for the freedom of movement of the vehicle and improve the maneuverability of a towed trailer or other device. For example, some embodiments may use casters or another form of an omnidirectional wheel.

As can be appreciated, the use of a device such as that illustrated in FIG. 31 can improve the maneuverability of a towed trailer. With a single front wheel point of contact and an omnidirectional point of contact with the rear of the vehicle, the vehicle can allow for easier movement of the towed trailer by removing the limitation of a single point of contact in the rear wheel. This is because it allows for quick and easy movement in any direction by providing a wheel or wheels not confined to a single direction as a traditional wheel does.

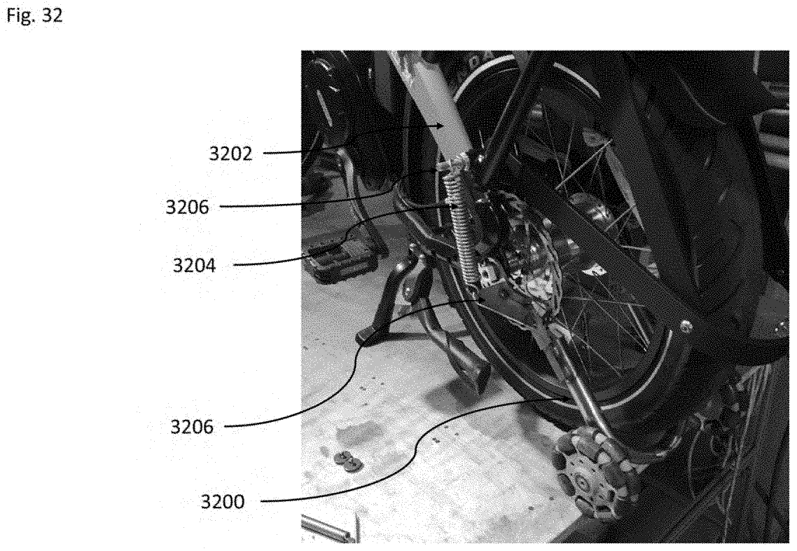

Since the vehicle may not always be maneuvering a trailer in a rearward motion, it can be appreciated that the maneuverability device can have a number of different positions at least an engaged and disengaged position. By engaged, it is meant that the maneuverability device is in a position that engages with the ground. Disengaged refers to the opposite of engaged where the wheels of the maneuverability are not in contact with the ground. In order to allow for the movement of maneuverability device, many embodiments may have one or more engagement mechanisms as illustrated in FIG. 32. For example, FIG. 32 illustrates a maneuverability device 3200 that is connected to a vehicle frame 3202. In a number of embodiments, the device 3200 is equipped with an engagement mechanism 3204 that can allow for the movement of the device between the different positions. In various embodiments the engagement mechanism 3204 may be a resilient type device such as a spring. Other embodiments may use a different engagement mechanism 3204 such as a hydraulic mechanism or any other type that can allow for the movement of the device 3200 to be moved and/or retained in one position or the other. Various embodiments may provide that the engagement mechanism is connected to the frame 3202 and the device 3200 by attachment points 3206 and 3208 respectively. It can be appreciated that the device attachment point 3208 can be flange with mounting holes or any other suitable device. In such exemplary embodiments, the attachment point can be integrated with the maneuver device.

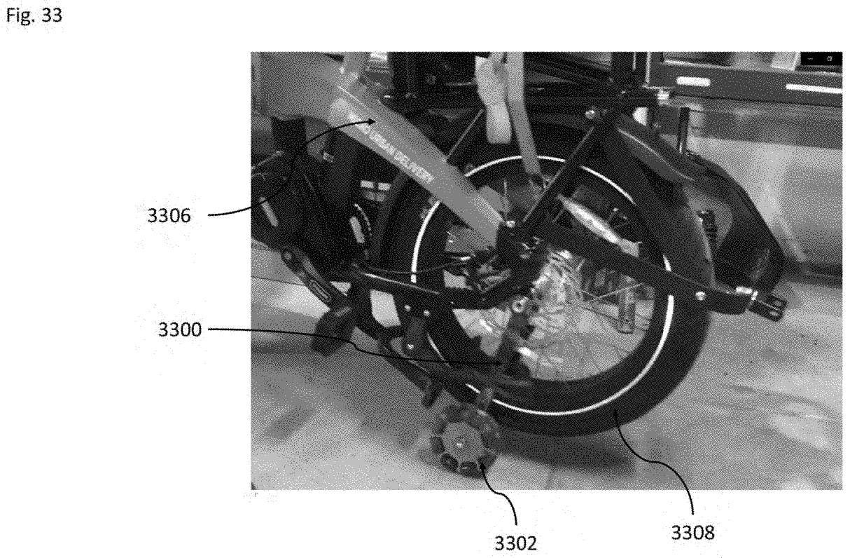

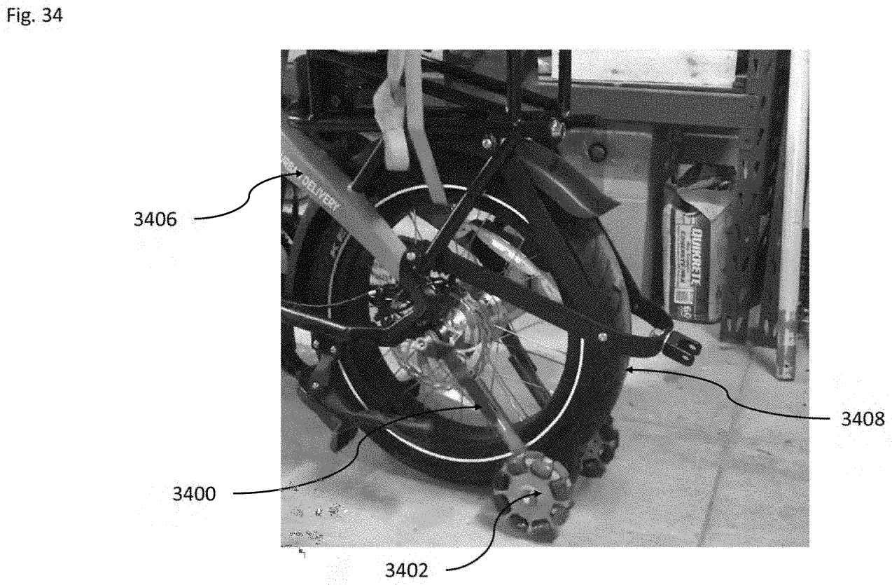

FIGS. 33 and 34 illustrate a maneuver device (3300 and 3400) positioned in the various engaged (FIG. 33) and disengaged (FIG. 34). As can be appreciated the omnidirectional wheels (3302 and 3402) may be positioned beneath (FIG. 33) or behind (FIG. 34) the vehicle (3306 and 3406). As can be appreciated, this can be done by way of the engagement mechanism previously illustrated. As illustrated in FIG. 33, the maneuver device 3300 is engaged such that the maneuverability wheels 3302 are disposed beneath the rear tire 3308 of the vehicle 3306. In contrast, FIG. 34 illustrates the maneuver device 3400 in a disengaged position where the wheels 3402 are disposed behind the rear tire 3408.

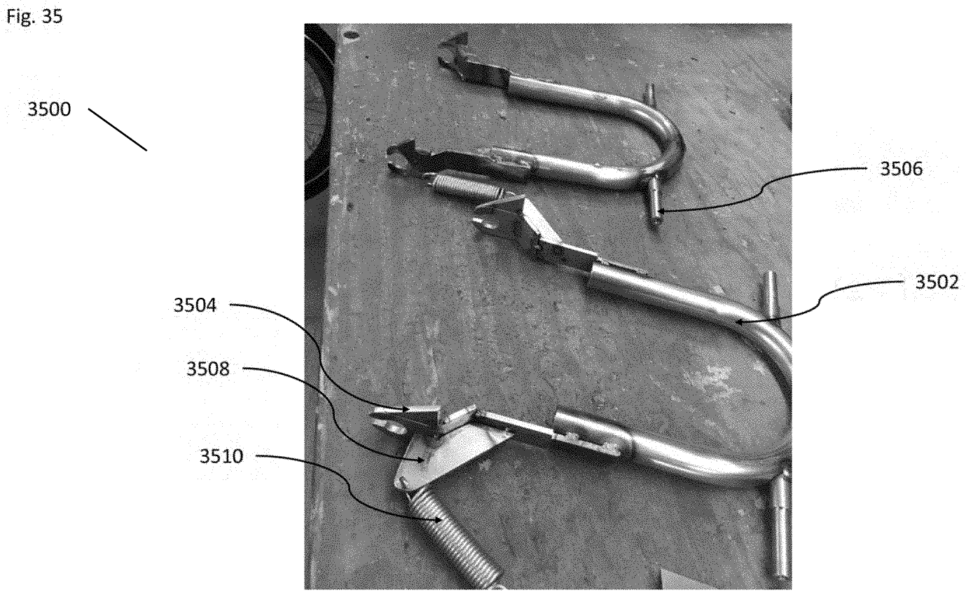

Turning now to FIG. 35, it can be appreciated that the maneuverability device can have a number of different configurations to position the omnidirectional wheels in the engaged and/or disengaged position. For example, FIG. 35 illustrates an embodiment of a device 3500 configured to support two wheels to allow for the maneuverability of a trailer. In various embodiments, the device can have a frame structure 3502 that has at least one attachment point 3504 that can attach the device to the frame of a vehicle. In many embodiments the device can be configured to attach to both sides of a vehicle and thus can be configured in a “U” shape. Additionally, the device 3500 can be configured with one or more axles 3506 to support the omnidirectional wheels (not shown). As can be further appreciated, the device 3500 can have one or more attachment points 508 that can allow for an engagement mechanism 3510 to be attached to the device. Although a certain configuration of the device is illustrated in FIG. 35, it can be appreciated that any variety of configurations can be used such that the device 3500 can be moved to a variety of positions and provide the maneuverability of a vehicle when attempting to tow or move a trailer.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A compactible hauler comprising:
a frame supporting a platform, wherein said frame and platform are formed of at least front and rear portions pivotably interconnected along a longitudinal axis thereof such that said at least two portions may be rotated between a first position where the portions are disposed in-line with each other and a second position where the portions are disposed in adjacent parallel planes, and
at least two sets of wheels, wherein at least one set of wheels is disposed on a front portion and wherein at least one set of wheels is disposed on a rear portion, and wherein when the portions are disposed in the second position the sets of wheels overlap,
wherein the rear wheels are pivotable relative to the frame and platform such that in a first position the rear and portions are disposed at the same height, and wherein in a second position the rear portion is dispose at a height lower than the front portion.

2. The compactible hauler of claim 1, further comprising a deployment mechanism disposed on a portion of the frame wherein the deployment mechanism is interconnected with the rear wheels such that a movement of the deployment mechanism can pivot the rear wheels between the first and second positions.

3. The compactible hauler of claim 1, further comprising a resilient element connected to the pivotable rear wheels wherein the resilient element is configured to apply a force against the rear wheels in either the first or second positions such that the hauler will remain fixed in either position.

4. The compactible hauler of claim 3, wherein the resilient element is connected to the frame through a plurality of pivotable elements and wherein the pivotable elements are disposed to the rear of the pivotable rear wheel.

5. The compactible hauler of claim 3, wherein the resilient element is connected to the frame through a plurality of pivotable elements and wherein the pivotable elements are disposed to forward of the pivotable rear wheel.

6. The compactible hauler of claim 1 wherein a single wheel is disposed on the front portion and a set of two wheels are disposed on the rear portion.

7. The compactible hauler of claim 1, wherein the platform further comprises a center open section configured such that the single wheel on the front portion passes at least partially therethrough when disposed in the second position.

8. The compactible hauler of claim 1 further comprising a surge braking mechanism disposed on the front portion.

9. The compactible hauler of claim 8, wherein the surge braking mechanism comprises:
at least a first brake support member interconnected with the hauler frame;
at least a second brake support member pivotably interconnected with the first brake support member and configured to be interconnected with a propulsion device at an end distal to the second brake support member;
a pneumatic brake element having a pneumatic cylinder fixedly interconnected to the second brake support member, and a rod having a resilient member disposed thereon, the rod slidingly engaged within the pneumatic cylinder at a first end and fixedly interconnected to the first brake support member; and
wherein when the first brake support member is pivoted in the direction of the second brake support member the rod is pushed into the pneumatic cylinder applying the braking mechanism.

10. The compactible hauler of claim 1, wherein the platform is configured to support a compactible cart comprising:
a support structure comprising a pair of longitudinal sidewall elements disposed parallel to each other and a pair of latitudinal end wall elements disposed parallel to each other, wherein the sidewall and end wall elements are pivotably interconnected at each end to each other such that said sidewall and end wall elements may be rotated between a first wall position where the sidewalls and end walls are disposed orthogonal to each other forming an internal volume and a second wall position where the sidewalls and end walls are disposed parallel to each other,
at least a top platform element pivotably interconnected to one of either the sidewall or end wall elements at an upper end thereof, and a bottom platform element pivotably interconnected to one of either the sidewall or the end wall elements at a lower end thereof, such that said internal platform elements may be rotated between a first platform position where said internal platform elements are disposed parallel to the side and end walls and a second platform position where said internal platform elements are disposed perpendicular to the side and end walls, and
a plurality of wheels disposed below the bottom platform, wherein at least one wheel is disposed at each of the corners of the cart,
wherein the elements of the cart are configured such that when at least one of the top or bottom platform elements are disposed in the second platform position the sidewall and end wall elements are prevented from pivoting; and
at least one locking mechanism having a first portion disposed on the hauler and a second cooperative portion disposed on the container such that when the container is positioned within the hauler the at least one locking mechanism is engaged to secure the container within the hauler.

11. The compactible hauler of claim 1, wherein the platform is disposed at a height of below five feet to the ground.

12. The compactible hauler of claim 1, further comprising a set of elongated illuminated masts disposed at each of the approximate corners of the frame and configured to pivot between a first configuration where the elongated illuminated masts extends above and normal to the plane of the frame, and a second configuration where the elongated illuminated masts extend along the plane of the frame.

13. A delivery system comprising:
a compactible hauler comprising:
a frame supporting a platform, wherein said frame and platform are formed of at least front and rear portions pivotably interconnected along a longitudinal axis thereof such that said at least two portions may be rotated between a first position where the portions are disposed in-line with each other and a second position where the portions are disposed in adjacent parallel planes, and
at least two sets of wheels, wherein at least one set of wheels is disposed on a front portion and wherein at least one set of wheels is disposed on a rear portion, and wherein when the portions are disposed in the second position the sets of wheels overlap,
wherein the rear wheels are pivotable relative to the frame and platform such that in a first position the rear and portions are disposed at the same height, and wherein in a second position the rear portion is dispose at a height lower than the front portion; and
wherein the platform is configured to support a compactible cart comprising:
a support structure comprising a pair of longitudinal sidewall elements disposed parallel to each other and a pair of latitudinal end wall elements disposed parallel to each other, wherein the sidewall and end wall elements are pivotably interconnected at each end to each other such that said sidewall and end wall elements may be rotated between a first wall position where the sidewalls and end walls are disposed orthogonal to each other forming an internal volume and a second wall position where the sidewalls and end walls are disposed parallel to each other,
at least a top platform element pivotably interconnected to one of either the sidewall or end wall elements at an upper end thereof, and a bottom platform element pivotably interconnected to one of either the sidewall or the end wall elements at a lower end thereof, such that said internal platform elements may be rotated between a first platform position where said internal platform elements are disposed parallel to the side and end walls and a second platform position where said internal platform elements are disposed perpendicular to the side and end walls, and
a plurality of wheels disposed below the bottom platform, wherein at least one wheel is disposed at each of the corners of the cart,
wherein the elements of the cart are configured such that when at least one of the top or bottom platform elements are disposed in the second platform position the sidewall and end wall elements are prevented from pivoting; and
at least one locking mechanism having a first portion disposed on the hauler and a second cooperative portion disposed on the container such that when the container is positioned within the hauler the at least one locking mechanism is engaged to secure the container within the hauler.

14. The delivery system of claim 13, further comprising a propulsion device interconnectable with the compactible hauler.

15. The delivery system of claim 13, wherein the propulsion device is a compactible electric scooter.

16. A vehicle maneuverability device comprising
a frame structure having at least one connection point and configured to cooperatively and rotatably engage with a vehicle frame work at a corresponding connection location on the vehicle framework, and wherein the at least one connection point is disposed at a first end of the frame structure;
at least one axle disposed on a lower portion of the frame structure wherein the at least one axle is configured to cooperatively engage with at least one wheel such that the length of the frame structure between the at least one connection point and an outer surface of the wheel is longer than a distance between the corresponding connection location and an outer surface of a vehicle tire;
wherein the frame structure has a disengaged position and an engaged position and can be rotated or moved between both the disengaged and engaged positions;
wherein in the disengaged position the at least one wheel is located rearward of the vehicle tire; and
wherein in the engaged position the at least one wheel is located lower than the vehicle tire such that the at least one wheel is in contact with the ground and the vehicle tire is not in contact with the ground.

17. The device of claim 16, wherein the at least one wheel is an omnidirectional wheel.

18. The device of claim 17, wherein the omnidirectional wheel is a Mecanum wheel.

19. The device of claim 17, wherein the frame structure is a “U” shape and wherein the at least one axle is disposed near the bottom curved portion of the “U” shape.

20. The device of claim 19, further comprising a second axle disposed on the frame structure on an opposing side of the at least one axle such that the position on each side of the frame structure of the at least one and second axles is equal.

21. The device of claim 20, further comprising at least a second wheel disposed on the second axle.

22. The device of claim 21, wherein each of the first and second wheels are omnidirectional wheels.

23. The device of claim 17, further comprising an engagement mechanism having a first end that is connected to a portion of the frame structure and a second end connected to the vehicle frame work, wherein the engagement mechanism provides mechanical assistance to move the device between the engaged and disengaged positions.

24. The device of claim 23, wherein the engagement mechanism holds the device in the disengaged position without additional external force.

25. The device of claim 23 wherein the engagement mechanism is a spring.

26. The device of claim 23, wherein the engagement mechanism is a hydraulic device
